(19) United States
(12) Patent Application Publication
(10) Pub. No.: US 2026/0301004 A1
(43) Pub. Date: Oct. 1, 2026

(54) SYSTEMS AND METHODS FOR PREDICTING USER TASKS ACROSS DIGITAL AND COMMUNICATION CHANNELS USING MULTIMODAL CUSTOMER INTERACTION SEQUENCES

(71) Applicant: FMR LLC, Boston, MA (US)

(72) Inventors: Devanga Kotha Aswarthanarayana, Bangalore (IN); Sidhant Pravinkumar Thole, Bangalore (IN); Manish Gupta, Bangalore (IN); Sunil Sharma, Mathura (IN); Sachin Umrao, Bangalore (IN); Bibhash Chakrabarty, Bangalore (IN)

(21) Appl. No.: 19/702,728

(22) Filed: Jun. 9, 2026

Related U.S. Application Data
(63) Continuation-in-part of application No. 19/051,498, filed on Feb. 12, 2025, now Pat. No. 12,675,542.

(51) Int. Cl. G06Q 30/0201; G06Q 30/0202

(52) U.S. Cl. CPC G06Q 30/020112; G06Q 30/0202

(57) ABSTRACT

A system and method predict tasks that a user is likely to perform across interaction channels. Historical customer interaction data is received from a plurality of channels and converted into multimodal event records. Each multimodal event record may include an event identifier, timestamp, channel identifier, and modality-specific features, such as page content, graph-location information, session context, call-summary text, conversation data, mobile activity data, profile attributes, or task-completion data. The multimodal event records are arranged into customer interaction sequences and encoded using control tokens and data tokens. A foundation model is pretrained using the encoded sequences and fine-tuned using user attribute data and user task data to predict tasks from partial interaction sequences. During an ongoing user session, the fine-tuned model predicts one or more tasks before task completion, and recommended content items or other outputs are generated based on the predicted tasks.

### RELATED APPLICATIONS

This application is a continuation-in-part of U.S. patent application Ser. No. 19/051,498, filed Feb. 12, 2025, the entirety of which is incorporated herein by reference.

### TECHNICAL FIELD

This application relates generally to systems and methods, including computer program products, for predicting tasks, intents, or activities that users are likely to perform using digital platforms, communication channels, service channels, or combinations thereof. More particularly, this application relates to using machine learning models, including language models, large language models, transformer models, and foundation models, to process multimodal customer interaction sequences including webpage visits, mobile activity, call summaries, conversation data, profile attributes, page content information, graph location information, and task completion information.

### BACKGROUND

It is usually the objective of most digital platforms (e.g., websites) to enhance user experience via increased personalization. The notion is that personalization causes users to access the digital platform more often because the content on the digital platform becomes more engaging and relevant to the user. Likewise, forecasting tasks to recommend content (e.g., purchasing products or services) may save the user time thereby increasing the user's likelihood of frequently accessing the digital platform as a result of the efficiency that it affords the user. Nevertheless, forecasting user tasks is conventionally considered to be a classification problem that can be solved by using machine learning models that are trained to classify one or more input data to a specific class or category. However, there are limitations in the classification machine learning model due to issues such as the multi-label problem (in which an input can belong to multiple classes or categories simultaneously), skewed task category distribution, etc. Because of such limitations, the tasks predicted according to conventional machine learning models are usually inferior. As such, there remains a need for a method or system that is capable of forecasting user tasks on a digital platform accurately.

Conventional systems may treat task prediction as a discriminative classification problem in which engineered features, such as page history, user profile attributes, and session-level attributes, are mapped to one or more fixed task classes. Such systems can suffer from degraded performance when task labels are skewed, when a user may be associated with multiple simultaneous or near-term intents, or when a user's actions unfold sequentially across multiple interaction channels.

In addition, conventional systems may be limited to a single interaction channel, such as a website clickstream, and may not adequately model relationships between digital activity and other user interactions. For example, a particular sequence of webpage visits may consistently precede a service call, a call center resolution may influence subsequent digital navigation, or a mobile interaction may indicate intent that is not apparent from website activity alone. Systems that process these channels separately may discard temporal, semantic, or contextual relationships among the channels.

Existing systems may also require separate data pipelines, feature stores, models, and prediction services for different interaction channels or data modalities. Such fragmented architectures can increase model-serving complexity, duplicate storage of interaction features, and prevent the model from learning temporal dependencies between events that occur in different channels. In addition, conventional feature-based systems may discard information when heterogeneous inputs are reduced to fixed classification features, thereby limiting the ability of the system to process incomplete sessions, missing modalities, unknown digital content identifiers, or interactions that occur out of a single channel order.

Accordingly, there remains a need for systems and methods that represent customer behavior as a unified multimodal sequence and that infer likely future tasks across interaction channels before the user completes or expressly initiates such tasks.

### SUMMARY

The present disclosure, in one aspect, features a computing system for predicting tasks that a user performs on a website, the system comprising a server computing device having a memory for storing computer-executable instructions and a processor that executes the computer-executable instructions to: train a machine learning model, at a first stage, based on one or more page session data corresponding to users who have previously accessed the website, wherein each page session data includes one or more page flows, each page flow being a sequence of webpages on the website that have been accessed in a single user session, and wherein the one or more page session data is obtained from one or more databases associated with the website; train the machine learning model, at a second stage, wherein the machine learning model is trained based on page session data, of the one or more page session data, that is associated with the user, user attribute data, and user task data, and wherein the user attribute data and the user task data are obtained from the one or more databases associated with the website; and determine, by the machine learning model, in response to an initiation of a user session based on a request from a user to access the website, one or more predicted tasks after a predetermined number of pages on the website have been accessed by the user in the user session, wherein the one or more predicted tasks are determined based on at least one of the predetermined number of pages and the one or more user attributes.

During the first stage, the machine learning model interprets each webpage, that is associated with a corresponding page flow of the one or more page flows, as a lexical token and is trained to determine a page embedding for each lexical token. During the second stage, the machine learning model is fine-tuned to determine predicted tasks by attempting to correctly determine a task that is associated with the page flow based on a partial sequence of webpages in the page flow. The computer executable instructions cause the processor to perform further operations to: generate one or more recommended content items based on the one or more predicted tasks, wherein the one or more recommended content items are displayed before the user on a page of the website that is currently being accessed by the user. The page of the website that is currently being accessed by the user is generated by modifying the page, wherein the modification of the page includes rearranging one or more existing content items on the page to accommodate the one or more recommended content items. The page of the website that is currently being accessed by the user includes a chatbot, and the chatbot includes an input section to receive queries from the user, an output section to display a response to the queries, and a recommended content section that includes the one or more recommended content items. The recommended content items in the recommended content section are each associated with a query that was generated or extracted based on a corresponding predicted task of the one or more predicted tasks.

The present disclosure, in another aspect, features a non-transitory computer-readable medium including computer-executable instructions that, when executed by a computing device, causes the computing device to: train a machine learning model, at a first stage, based on one or more page session data corresponding to users who have previously accessed the website, where each page session data includes one or more page flows, each page flow being a sequence of webpages on the website that have been accessed in a single user session, and wherein the one or more page session data is obtained from one or more databases associated with the website; train the machine learning model, at a second stage, wherein the machine learning model is trained based on page session data, of the one or more page session data, that is associated with the user, user attribute data, and user task data, and wherein the user attribute data and the user task data are obtained from the one or more databases associated with the website; and determine, by the machine learning model, in response to an initiation of a user session based on a request from a user to access the website, one or more predicted tasks after a predetermined number of pages on the website have been accessed by the user in the user session, wherein the one or more predicted tasks are determined based on at least one of the predetermined number of pages and the one or more user attributes.

The computer-executable instructions cause the computing device to perform further operations to: extract, in real time, a plurality of accessed webpages that have been accessed by the user within a predetermined time period. The machine learning model determines at least one predicted task after an end of the predetermined time period, wherein the at least one predicted task is determined by the machine learning model based on the plurality of accessed webpages. The computer executable instructions cause the computing device to perform further operations to: determine one or more accessed webpages of the plurality of accessed webpages, the one or more accessed webpages being a subset of the plurality of accessed webpages, wherein the machine learning model determines at least one predicted task after an end of the predetermined time period, and wherein the at least one predicted task is determined by the machine learning model based on the one or more accessed webpages. The computer executable instructions cause the computing device to perform further operations to: retrieve trend data corresponding to one or more trends associated with completing tasks by other users at predetermined time intervals, wherein the trend data corresponds to trends identified over a predetermined period of time; and train the machine learning model based on the trend data, wherein the predicted task is determined based in part on the trend data. Each page on the website includes a page identifier that is mapped to one or more tasks, and wherein the machine learning model determines the predicted task based on a sequence of page identifiers corresponding to the one or more predetermined number of pages. The user task data includes one or more tasks that have been previously completed by the user on the website.

The present disclosure, in a further aspect, features a computerized method for predicting tasks that a user performs on a website, the method comprising: training a machine learning model, at a first stage, based on one or more page session data corresponding to users who have previously accessed the website, wherein each page session data includes one or more page flows, each page flow being a sequence of webpages on the website that have been accessed in a single user session, and wherein the one or more page session data is obtained from one or more databases associated with the website; training the machine learning model, at a second stage, wherein the machine learning model is trained based on page session data, of the one or more page session data, that is associated with the user, user attribute data, and user task data, and wherein the user attribute data and the user task data are obtained from the one or more databases associated with the website; and determining, by the machine learning model, in response to an initiation of a user session based on a request from a user to access the website, one or more predicted tasks after a predetermined number of pages on the website have been accessed by the user in the user session, wherein the one or more predicted tasks are determined based on at least one of the predetermined number of pages and the one or more user attributes.

Each page session data further includes, for each page flow, a time corresponding to when each webpage in the page flow was accessed, and a page identifier associated with each webpage in the page flow. The page session data is stored in a page sessions database, the user attribute data is stored in a user attributes database, and the user task data is stored in a user tasks database. The user attribute data includes at least one of demographics, employment, income, assets, academic achievements, licenses, physical address, bank accounts, and financial accounts. The machine learning model is at least one of a language model and a large language model (LLM). The user session is initiated when the user logs onto an account on the website that is associated with the user, and the user session expires when the user logs off the account or when the user is inactive on the website for a predetermined period of time.

The present disclosure, in another aspect, features a computing system for predicting one or more tasks, intents, or activities that a user is likely to perform across a plurality of interaction channels. The computing system comprises at least one server computing device having a memory for storing computer-executable instructions and a processor configured to execute the computer-executable instructions to receive historical customer interaction data associated with a plurality of users, the historical customer interaction data comprising interaction data from a plurality of interaction channels.

The processor is further configured to generate, from the historical customer interaction data, a plurality of multimodal event records. Each multimodal event record corresponds to a customer interaction and includes at least one channel identifier and one or more modality-specific features. The modality-specific features may include, for example, webpage identifiers, page content embeddings, website graph embeddings, timestamps, session context data, call summary text, conversation data, mobile activity data, user-profile attributes, transaction attributes, and completed task identifiers.

The processor is further configured to generate a unified customer interaction sequence by arranging the multimodal event records according to time and by encoding the multimodal event records using control tokens associated with different interaction channels or data types. The processor trains a foundation model using the unified customer interaction sequence, wherein the foundation model learns temporal, contextual, and cross-channel relationships among customer interactions from different modalities.

The processor is further configured to fine-tune the foundation model using training sequences that include customer profile information, historical click sessions, call summaries, and completed-task identifiers expressed according to a channel-agnostic task taxonomy. During inference, the processor generates an input sequence including at least a partial ongoing interaction sequence associated with a user and one or more available user-context modalities, applies the fine-tuned foundation model to the input sequence, and determines one or more predicted tasks that the user is likely to perform across one or more interaction channels.

In some embodiments, the disclosed systems improve operation of a computer-based task-prediction system by converting heterogeneous structured and unstructured interaction data into a unified sequence representation that can be processed by a single sequence model. For example, the system may reduce or eliminate the need for separate channel-specific prediction models by encoding webpage events, mobile events, call summaries, conversation data, profile attributes, and completed-task identifiers into a common token and embedding framework. In some embodiments, the system improves model operation by generating event embeddings that preserve temporal, semantic, graph-location, session-context, and channel information for individual customer interactions, thereby enabling the model to predict cross-channel tasks from partial interaction sequences before task completion

The processor is further configured to generate one or more recommended outputs based on the one or more predicted tasks before the user expressly initiates or completes the one or more predicted tasks and, in some embodiments, independently of explicit user approval to create a task record. The recommended outputs may include recommended content items, recommended questions, product recommendations, service routing actions, virtual assistant starter questions, branch service recommendations, user interface modifications, or next-best-action outputs.

In some embodiments, the disclosed systems improve operation of a computer-based task prediction system by converting heterogeneous structured and unstructured interaction data into a unified sequence representation that can be processed by a single sequence model. For example, the system may reduce or eliminate the need for separate channel-specific prediction models by encoding webpage events, mobile events, call summaries, conversation data, profile attributes, and completed task identifiers into a common token and embedding framework. In some embodiments, the system improves model operation by generating event embeddings that preserve temporal, semantic, graph location, session context, and channel information for individual customer interactions, thereby enabling the model to predict cross-channel tasks from partial interaction sequences before task completion.

The present disclosure, in another aspect, features a computerized method of predicting tasks that a user performs across one or more interaction channels. At a first stage, a machine learning model is trained based on historical customer interaction data corresponding to each of one or more users who have previously interacted with a website or one or more additional interaction channels, where the historical customer interaction data includes one or more customer interaction sequences, each customer interaction sequence being a sequence of multimodal event records associated with a user session or user journey, where each multimodal event record corresponds to a customer interaction and includes an event identifier, a timestamp, a channel identifier, and one or more modality-specific features, and where, during the first stage, each multimodal event record in a customer interaction sequence is interpreted as a lexical token and the machine learning model is trained to generate an event embedding for each lexical token based upon model learning derived from past customer interaction sequences. At a second stage, the machine learning model is trained based on customer interaction data, user attribute data, and user task data, where the second stage comprises fine-tuning the machine learning model to predict a task associated with a training customer interaction sequence using only a partial sequence of multimodal event records from the training customer interaction sequence. The machine learning model determines, during an ongoing user session and prior to completion of a task, one or more predicted tasks after a predetermined number of customer interactions have occurred in the ongoing user session, where the one or more predicted tasks are determined based on at least one of the predetermined number of customer interactions and the user attribute data. One or more recommended content items are generated based on the one or more predicted tasks, where the one or more recommended content items are displayed to the user on a page or interface that is currently being accessed by the user and where the one or more recommended content items are generated independently of an explicit user approval to create a task record.

The present disclosure, in another aspect, features a system for predicting tasks that a user performs across one or more interaction channels. The system comprises a computing device with a memory for storing computer-executable instructions and one or more processors that execute the computer-executable instructions. At a first stage, the computing device trains a machine learning model based on historical customer interaction data corresponding to each of one or more users who have previously interacted with a website or one or more additional interaction channels, where the historical customer interaction data includes one or more customer interaction sequences, each customer interaction sequence being a sequence of multimodal event records associated with a user session or user journey, where each multimodal event record corresponds to a customer interaction and includes an event identifier, a timestamp, a channel identifier, and one or more modality-specific features, and where, during the first stage, each multimodal event record in a customer interaction sequence is interpreted as a lexical token and the machine learning model is trained to generate an event embedding for each lexical token based upon model learning derived from past customer interaction sequences. At a second stage, the computing device trains the machine learning model based on customer interaction data, user attribute data, and user task data, where the second stage comprises fine-tuning the machine learning model to predict a task associated with a training customer interaction sequence using only a partial sequence of multimodal event records from the training customer interaction sequence. The machine learning model determines, during an ongoing user session and prior to completion of a task, one or more predicted tasks after a predetermined number of customer interactions have occurred in the ongoing user session, where the one or more predicted tasks are determined based on at least one of the predetermined number of customer interactions and the user attribute data. The computing device generates one or more recommended content items are generated based on the one or more predicted tasks, where the one or more recommended content items are displayed to the user on a page or interface that is currently being accessed by the user and where the one or more recommended content items are generated independently of an explicit user approval to create a task record.

Any of the above aspects can include one or more of the following features. In some embodiments, interpreting each multimodal event record as a lexical token comprises mapping each multimodal event record to a discrete event identifier representing the corresponding customer interaction within the machine learning model. In some embodiments, the discrete event identifier is derived from at least one of a URL, a canonicalized URL, a page hash, an internal page reference, a mobile screen identifier, a call event identifier, a channel identifier, or a task identifier.

In some embodiments, the user task data includes one or more tasks that have been previously completed by the user through at least one of the website or the one or more additional interaction channels, and wherein the one or more tasks are expressed according to a channel-agnostic task taxonomy. In some embodiments, the one or more predicted tasks include a predicted task likely to be performed through an interaction channel different from an interaction channel of at least one customer interaction in the partial sequence of multimodal event records.

In some embodiments, the computing device extracts, in real time, a plurality of customer interactions that have occurred within a predetermined time period during the ongoing user session. In some embodiments, the computing device determines one or more customer interactions of the plurality of customer interactions, the one or more customer interactions being a subset of the plurality of customer interactions, wherein the machine learning model determines at least one predicted task after an end of the predetermined time period, and wherein the at least one predicted task is determined by the machine learning model based on the one or more customer interactions.

In some embodiments, the partial sequence of multimodal event records excludes at least one multimodal event record associated with completion of the predicted task. In some embodiments, the predicted task is determined prior to user interaction with a webpage, mobile screen, call interaction, chatbot interaction, advisor interaction, branch service interaction, or other interaction point that initiates execution of the predicted task. In some embodiments, the page or interface that is currently being accessed by the user includes a chatbot, wherein the chatbot includes an input section to receive queries from the user, an output section to display a response to the queries, and a recommended content section that includes the one or more recommended content items, and wherein the recommended content items in the recommended content section are each associated with a query that was generated or extracted based on a corresponding predicted task of the one or more predicted tasks.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for predicting tasks that a user performs on a website and, in some embodiments, across one or more additional interaction channels.

FIG. 2 is a system flow diagram illustrating an offline pretraining phase, an offline fine-tuning phase, and a live inference phase for predicting tasks that a user performs on a website and, in some embodiments, across multiple interaction channels.

FIG. 3 is a flow diagram of a computerized method for predicting tasks that a user performs on a website, illustrating an offline pretraining phase, an offline fine-tuning phase, and a real-time inference phase, and in some embodiments, using multimodal customer interaction sequences.

FIG. 4A is an example diagram of a table indicating an example of a page session which includes information regarding webpages that have been visited by the user.

FIG. 4B is an example diagram of a table indicating an example of tasks that have been predicted based on page flows in page sessions associated with user sessions.

FIG. 5A is an example diagram illustrating how a machine learning model is trained to predict next page using page flows, according to some embodiments.

FIG. 5B is an example diagram illustrating how a machine learning model may be fine-tuned to accurately predict tasks using a partial page flow, according to some embodiments.

FIG. 5C is an example diagram illustrating how a machine learning model predicts tasks that a user performs on a website, according to some embodiments.

FIG. 6 is an example diagram illustrating a user interface displaying a webpage of a website that includes recommended content that was generated based on a predicted task.

FIG. 7 is a diagram of an illustrative computing system.

FIG. 8 is an example diagram illustrating a multimodal event record including a channel identifier and a plurality of modality-specific features.

FIG. 9A is an example diagram illustrating generation of a unified customer interaction sequence for offline pretraining of a foundation model using historical customer interaction data.

FIG. 9B is an example diagram illustrating generation of a task prediction training sequence for offline fine-tuning of the foundation model using historical customer interaction data with task labels.

FIG. 9C is an example diagram illustrating generation of a partial multimodal input sequence for real-time inference using an ongoing user session.

FIG. 10 is an example flow diagram illustrating pretraining of a foundation model using historical customer interaction sequences including click session data and call summary data.

FIG. 11 is an example flow diagram illustrating fine-tuning of the foundation model using profile data, historical interaction data, call summary data, and completed task identifiers.

FIG. 12 is an example flow diagram illustrating inference using a partial ongoing interaction sequence and one or more available user context modalities to predict one or more tasks across one or more interaction channels.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

Although several examples are described below with reference to websites and webpage sequences, it should be appreciated that the disclosed systems and methods may also be applied to customer interactions across multiple channels, including websites, mobile applications, call centers, chatbot interfaces, virtual assistant interfaces, advisor interactions, branch service interactions, and other digital or communication channels. Accordingly, a webpage sequence may be one example of a broader customer interaction sequence, and a webpage event may be one example of a broader multimodal event. Similarly, a task performed on a website may be one example of a task, intent, or activity that may be predicted across one or more interaction channels.

The systems and methods described herein provide technical improvements to computer-based task prediction systems. In some embodiments, the system transforms heterogeneous customer interaction data from multiple channels into multimodal event records and unified customer interaction sequences that are processable by a single machine learning model. This may reduce the need to maintain separate channel-specific models, reduce duplication of feature engineering pipelines, and allow a single model to process interaction events from different modalities in temporal context.

In some embodiments, the system improves the representation of interaction data used by a machine learning model. For example, instead of representing a webpage visit only as a page identifier, the system may generate an event embedding that combines an event identifier, timestamp, channel identifier, page content information, graph location information, session context information, and other modality-specific features. The resulting event embedding may preserve information that would otherwise be discarded by single-channel or classification-based models.

In some embodiments, the system improves real-time inference by enabling a fine-tuned foundation model to predict one or more tasks from a partial multimodal input sequence before a task-completion event occurs. The system may process incomplete interaction sequences, omit unavailable modalities, use absence indicators for missing modalities, and update predictions as additional events occur. In some embodiments, the system uses the predicted tasks to automatically modify a page or interface, generate a chatbot prompt, route a service interaction, or provide a next-best-action output.

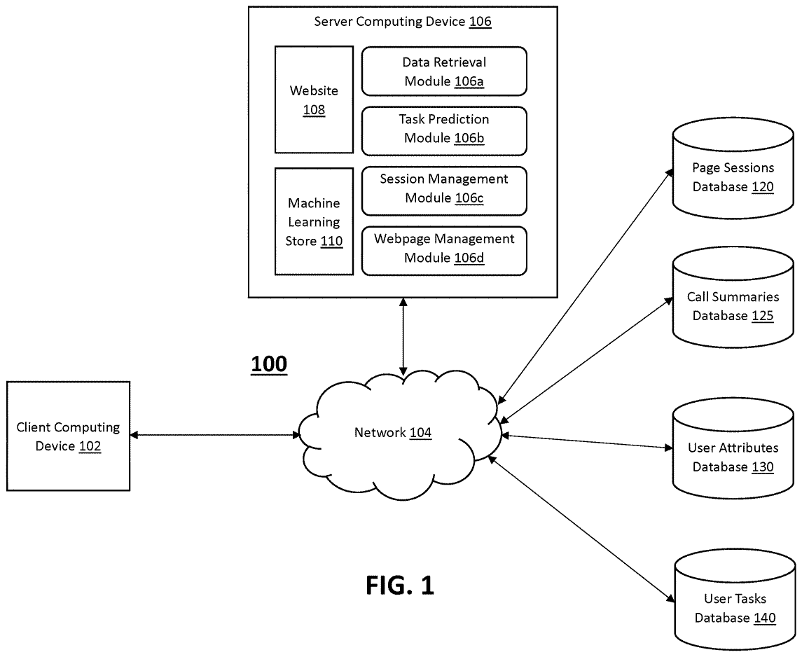

FIG. 1 is a block diagram of a system 100, which includes a client computing device 102, a server computing device 106, a page sessions database 120, a call summaries database 125, user attributes database 130, and a user tasks database 140, all of which are capable of communicating with each other via a communication network 104. In some embodiments, the system 100 may further include or communicate with one or more additional data sources, including a conversation log database, mobile activity database, advisor interaction database, branch service database, page content database, website graph database, task taxonomy database, or other customer interaction data source.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website (e.g., website 108), which can be reached by entering a uniform resource locator (URL). Exemplary client computing device 102 includes but is not limited to desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The server computing device 106 is a device including specialized hardware and/or software modules that execute on a processor and interact with memory modules of the server computing device 106, to transmit data to other components of the system 106, and to receive data from other components of the system 100, as described herein. The server computing device 106 includes several systems, frameworks, stores, and computing modules that execute on one or more processors of the server computing device 106. For example, the server computing device 106 includes a data retrieval module 106a, a task prediction module 106b, a session management module 106c, a webpage management module 106d, a website 108, and a machine learning store 110 (which can store all types of machine learning models, such as classification type machine learning model(s), regression type machine learning model(s), support vector machines (SVM) machine learning model(s), ensemble method machine learning model(s), neural network model(s), recurrent neural networks (e.g., long short term memory), deep learning model(s), transformer model(s), decoder-only transformer model(s), foundation model(s), generative artificial intelligence model(s), language model(s), or large language model(s)).

Although the data retrieval module 106a, the task prediction module 106b, the session management module 106c, the webpage management module 106d, the website 108, and the machine learning store 110 are shown in FIG. 1 as executing within the same server computing device 106, in some embodiments the functionality of the data retrieval module 106a, the task prediction module 106b, the session management module 106c, the webpage management module 106d, the website 108, and the machine learning store 110 can be distributed among a plurality of server computing devices. As shown in FIG. 1, the server computing device 106 allows the data retrieval module 106a, the task prediction module 106b, the session management module 106c, the webpage management module 106d, the website 108, and the machine learning store 110 to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the data retrieval module 106a, the task prediction module 106b, the session management module 106c, the webpage management module 106d, the website 108, and the machine learning store 110 are described in detail below.

The page sessions database 120 may be a computing device (or, in some embodiments, may be a set of computing devices) that is configured to provide, receive, and store various types of data associated with one or more page sessions that correspond to one or more users who, for example, have visited the website 108 or are registered with the website 108 (e.g., user is associated with a login account on the website). Each page session data (e.g., corresponding to a page session) includes a page flow that is associated with the webpages that the user has visited on the website 108. For example, the page flow may include the sequence of pages that have been displayed to a user in a page session.

In some embodiments, the page session may commence with the user logging into the website, in which a login session begins. In other embodiments, the page session may commence when a user first visits the website 108 (e.g., first time visiting or after period of inactivity). In some embodiments, the page session may end with the user logging off the login session. It should be noted that the user may log off the login session voluntarily (e.g., user clicks on logoff button) or involuntarily (e.g., user is inactive on the website for a predetermined time period). In other embodiments, the page session may end when it is detected that the user has been inactive on the website 108 for a predetermined period of time.

The user attribute database 130 may be a computing device (or, in some embodiments, may be a set of computing devices) that is configured to provide, receive, and store various types of data associated with user attributes. For example, the user attribute database 130 may store user attribute data for each user that is registered with the website 108 (e.g., via a login account). In another example, the user attribute database 130 may store user attribute data for each user that visits the website 108 (e.g., information obtained from cookies or server logs). User attribute data may include, but is not limited to, demographics (e.g., age, gender, nationality, ethnicity, religion), employment, income, assets, academic achievements, licenses, physical address, bank accounts, financial accounts (e.g., types of accounts (e.g., individual retirement account (IRA), health spending account (HSA)), total amount in account(s) invested with financial organization, etc.), etc. In some embodiments, the user attribute data is obtained when the user provides personal information (e.g., user attributes) in order to register with the website 108 to obtain a login account.

The user tasks database 140 may be a computing device (or, in some embodiments, may be a set of computing devices) that is configured to provide, receive, and store various types of data associated with user tasks. For example, the website 108 may allow the user to perform or complete one or more tasks (e.g., purchasing a product, making a transaction, registering for courses at a university, etc.). In some embodiments, the one or more tasks may additionally or alternatively be performed or completed through a mobile application, call center interaction, chatbot interaction, virtual assistant interaction, advisor interaction, branch service interaction, or other digital or communication channel interaction. In some embodiments, a task completion may be detected based on the occurrence of a specific event that is associated with the task (e.g., task event). In other embodiments, a task completion may be detected based on a webpage with which the user is provided (e.g., task of purchasing product is determined to be completed with the user is shown the order confirmation webpage). More specifically, one or more webpages of the website 108 may be associated with a task identifier, which may assist in determining whether a task has been completed.

In some embodiments, the system 100 may access additional data sources associated with customer interactions across a plurality of channels. For example, the system 100 may access a call summary database that stores call summaries generated from historical call interactions. The call summaries may be generated by an artificial intelligence model, natural language processing system, speech-to-text system, summarization model, or other automated or semi-automated system. The call summaries may include natural language descriptions of issues raised by users, resolutions provided to users, tasks completed during calls, or tasks inferred from calls.

In some embodiments, the system 100 may access a conversation log database that stores chat transcripts, chatbot conversations, virtual-assistant interactions, advisor conversations, service notes, or other text-based interactions. The conversation log database may include raw transcripts, generated summaries, extracted task identifiers, resolution identifiers, timestamps, channel identifiers, or combinations thereof.

In some embodiments, the system 100 may access a mobile activity database that stores mobile application events associated with one or more users. The mobile application events may include mobile screen identifiers, mobile session identifiers, timestamps, mobile task-completion events, mobile navigation events, or other mobile interaction data.

In some embodiments, the system 100 may access a page content database and a website graph database. The page content database may store text, semantic representations, or embeddings associated with webpages, mobile screens, or other digital content. The website graph database may store graph location data indicating relationships among webpages, mobile screens, digital content items, or navigation nodes. The graph location data may include node identifiers, edge identifiers, adjacency information, node embeddings, or graph embeddings.

In some embodiments, the system 100 may access a task taxonomy database that stores a plurality of task identifiers according to a channel-agnostic task taxonomy. The channel-agnostic task taxonomy may map tasks completed through different interaction channels to common task identifiers. For example, a beneficiary-update task may be represented by a common task identifier regardless of whether the task is completed through a website, mobile application, call-center interaction, advisor interaction, or branch-service interaction. The task identifiers may be represented as task tokens, such as T1 through TN, for use by a machine learning model.

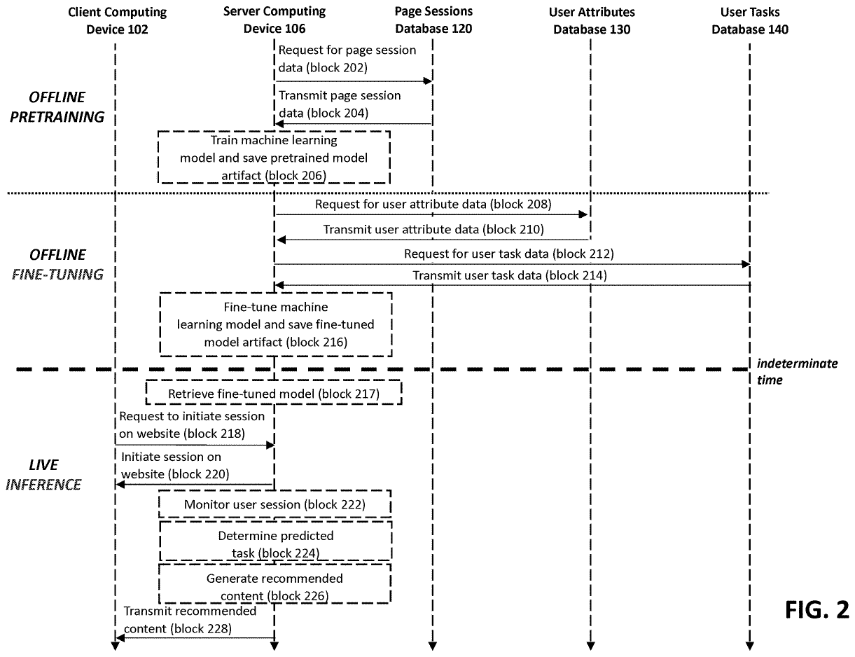

FIG. 2 illustrates an exemplary flow diagram corresponding to the system 100 of FIG. 1, in which the client computing device 102, the server computing device 106, the page sessions database 120, the user attributes database 130, and the user tasks database 140, communicate with each other to perform one or more actions. As shown in FIG. 2, blocks 202 to 206 comprise an offline pretraining phase. At block 202, the server computing device 106 transmits a request for page session data to the page sessions database 120. At block 204, in response to the request for page session data, the page sessions database 120 transmits the page session data to the server computing device 106. At block 206, the server computing device 106 uses the page session data to train a machine learning model (e.g., a machine learning model that is configured to predict user tasks on a website after being trained) and the server computing device 106 saves the pretrained model artifact (e.g., in ML store 110). It should be noted that the page session data may include the page session data for each (or every) user that has ever visited the website 108.

Once offline pretraining of the model and saving of the model artifact is complete, system 100 can conduct an offline fine-tuning phase comprising blocks 208 to 216. At block 208, the server computing device 106 transmits a request for user attribute data that is associated with the user. In response, at block 210, the user attributes database 130 transmits user attribute data to the server computing device 106. At block 212, the server computing device 106 transmits a request for user task data that is associated with the user. In response, at block 214, the user tasks database 140 transmits user task data to the server computing device 106.

At block 216, the server computing device 106 fine-tunes the machine learning model using the page session data that is associated with the user, the user attribute data that is associated with the user, and the user task data that is associated with the user. For example, the page session data that is associated with the user may have been previously obtained from the page sessions database 120 (e.g., at block 204). In some embodiments, the fine-tuning performed at block 216 may be performed using a unified customer interaction sequence that includes page session data, call summary data, user profile data, demographic data, transaction-related data, conversation data, mobile activity data, and completed task data. The completed task data may include tasks completed through different interaction channels and expressed using a channel-agnostic task taxonomy. In such embodiments, the machine learning model may be fine-tuned to predict one or more future tasks based on interaction data from multiple channels rather than based solely on page session data from a website. The server computing device 106 saves the fine-tuned model artifact (e.g., in ML store 110).

After an indeterminate period of time, system 100 can use the fine-tuned model for live inference comprising blocks 217 to 228. At block 217, the server computing device retrieves the fine-tuned model artifact (from ML store 110). At block 218, the server computing device 106 may receive a request to initiate a user session (e.g., user visiting a website or logging into a user account that is registered with the website). In response, at block 220, the server computing device 106 transmits a confirmation to the client computing device 102 indicating that a user session has been initiated according to the request (e.g., the server computing device 106 may transmit the web page corresponding to the URL in the request or may transmit a confirmation that the login has been successfully performed due to verified credentials provided by the user).

In some embodiments, the server computing device 106 may also store or publish the website 108. However, it should be noted that the server computing device 106 may not necessarily store or publish the website 108. In other words, the website 108 may be stored or published on another server computing device (e.g., a website publishing server computing device). The server computing device 106 may interact with the website publishing server computing device (e.g., via network 104) to facilitate different actions.

At block 222, the server computing device 106 monitors the user session while the user is visiting one or more webpages on the website. More specifically, the server computing device 106 may register or record the webpages that the user has visited during such user session. At block 224, the server computing device 106 causes the machine learning model to determine a predicted task based on the webpages that the user has visited during the user session. At block 226, the server computing device 106 generates recommended content based on the predicted task. At block 228, the server computing device 106 transmits the recommended content to the client computing device 102.

In some embodiments, blocks 222 through 228 may include monitoring an ongoing interaction sequence across one or more channels, generating a partial multimodal input sequence, predicting one or more tasks across channels, and generating a recommended experience, content item, product, chatbot prompt, service routing action, branch service action, virtual assistant starter question, or next-best-action output. For example, the machine learning model may predict, based on a partial website session and a prior call summary, that the user is likely to perform a task through a call center channel, mobile channel, advisor channel, or branch service channel.

### Example Routine for Predicting Tasks Based on Website and Multimodal Interaction Data

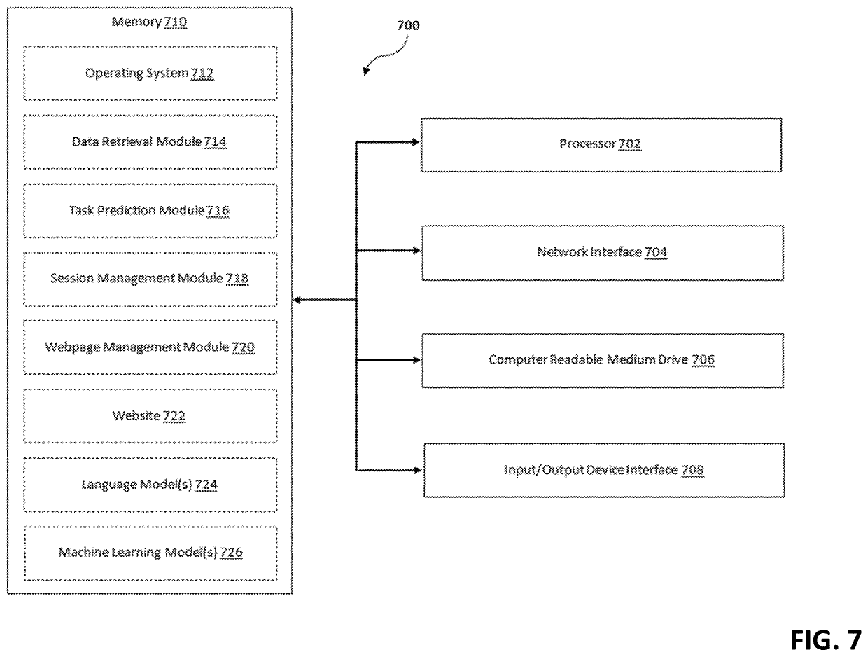

When a routine described herein (i.e., 300) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 700 shown in FIG. 7, and executed by one or more processors. In some embodiments, the routine 300 or portions thereof may be implemented on multiple processors, serially or in parallel.

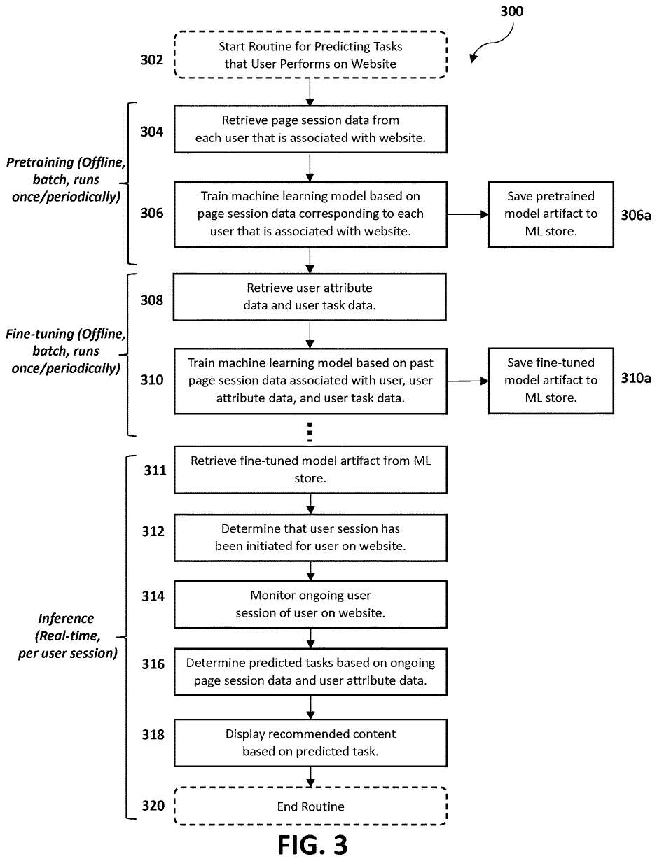

FIG. 3 illustrates example routine 300 (beginning at block 302) for predicting tasks that users perform on a website, that is performed, for example, by the server computing device 106. At block 304, the data retrieval module 106a of the server computing device 106 retrieves page session data from each user that is associated with the website 108. More specifically, the data retrieve module 106a may transmit a request to a page sessions database 120 to obtain the page session data. In response, the page sessions database 120 may transmit the page session data to the server computing device 106, where the page session data may be received by the data retrieval module 106a.

The website 108 may be stored or published on the server computing device 106. The website 108 may include one or more webpages that each may be a document that includes content (e.g., text, images, video, audio, etc.). In addition, the webpage may also include one or more graphical control elements. A graphical control element may be a component on the webpage with which the user is capable of interacting. For example, a graphical control element may include at least one of a button, widget, and icon. For example, the button may include a hyperlink (e.g., in the form of a uniform resource locator (URL)) that, when activated, causes the user to be taken to another webpage of the same or different website. It should be noted that a webpage may include multiple hyperlinks, each of which may bring the user to another webpage of the same or different website. In another example, a graphical control element may also include at least one of text fields (e.g., for inputting texts to, for example, search on a search engine), and option selectors (e.g., checkboxes, radio buttons, drop-down lists, sliders).

Further, it should also be noted that the webpage may also include a chatbot, which may be a software application or web interface that is configured to simulate human conversation through text or voice interactions. In some embodiments, the webpage may include a first section and a second section, in which the chatbot is disposed in the second section. The chatbot may operate using a machine learning model, such as a language model or a large language model (LLM) or may operate using a generative artificial intelligence (AI) model. Further, the chatbot may include an input section and an output section, in which the user may input text (e.g., a question or query) into the input section and may receive a response from the chatbot in the output section. For example, the chatbot may be a guide or virtual assistance that assists users in navigating the website or providing answers to questions that users have regarding the different tasks that the user is capable of performing on the website. In some embodiments, the chatbot is capable of continuing the conversation with the user even if the user has moved to another webpage within the same website.

The webpages may be created using at least one of Hypertext Markup Language (HTML), Cascading Style Sheets (CSS), and JavaScript. Each webpage of the website can be accessed independently by inputting a uniform resource locator (URL) into a web browser. A web browser is a software application that allows users to access (e.g., view) webpages. The web browser may be included on a client computing device (e.g., 102) of a user, in which the web browser provides a user interface to which the user can view the web pages upon having the user input the URL into the web browser. More specifically, after receiving the URL, the web browser sends a request (e.g., via a network, such as the internet) to the server computing device (e.g., 106), associated with such URL, that stores or publishes the website. In reply to such request, the server computing device may transmit a response that may include at least one of HTML, CSS, JavaScript code, images, audio, video, etc. The web browser interprets the HTML, CSS, and JavaScript code to generate the webpage.

As discussed previously, a user may be associated with the website 108. In other words, the user may be a visitor to the website (e.g., browsing) or may be registered with the website (e.g., have a login account). As such, whenever the user accesses the website (e.g., by logging in or by inputting the corresponding URL or using a hyperlink from another website, such as a search engine), the website 108 determines that a user session has commenced. The user session may end, for example, when the user has been inactive for a predetermined time period or user logs off the user session. It should be noted that during a user session, the user may view one or more webpages that are associated with the website.

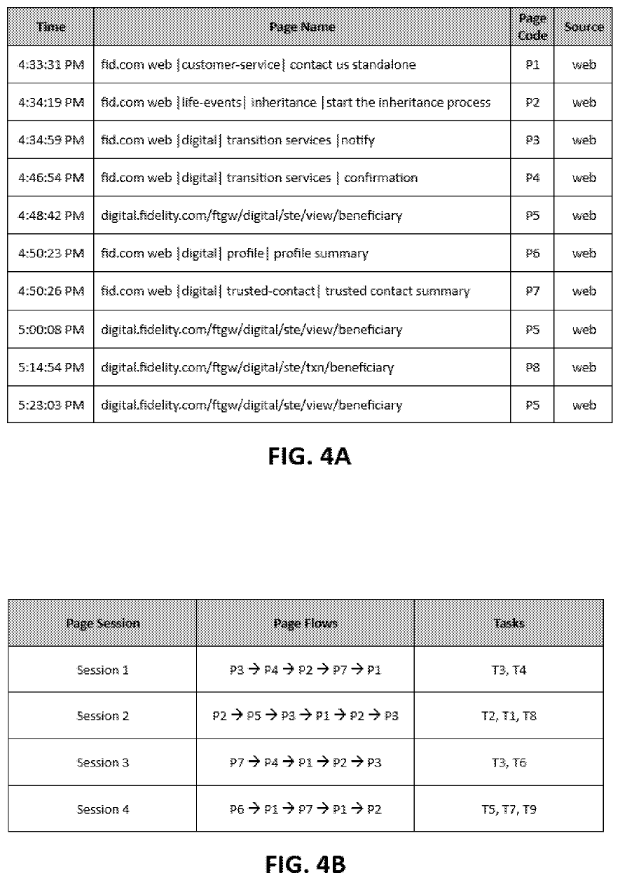

A page session is associated with each user session. The page session may include a page flow that indicates a sequence of web pages that the user has visited within the corresponding user session. An example of a page session data corresponding to a page session of a particular user session of a specific user is shown in FIG. 4A, in which the page session data includes webpage information for each webpage in the page flow, such as the page name (e.g., the URL of the page), the time at which the user accessed the page, the page identifier (e.g., page code) that is associated with each page, and the source of the page (e.g., web). As shown, the page flow of the webpages in the page session data is in sequence according to time (e.g., from the first webpage accessed to the last webpage accessed). It should be noted that there may be multiple users that interact with the website (e.g., website 108), and that each user may be associated with one or more user sessions (and by extension one or more page sessions corresponding to the one or more user sessions). As such, in some embodiments, the page session data may include page sessions for each (or every) user that has visited or accessed the website 108 at some point (a user may be associated with one or more page sessions).

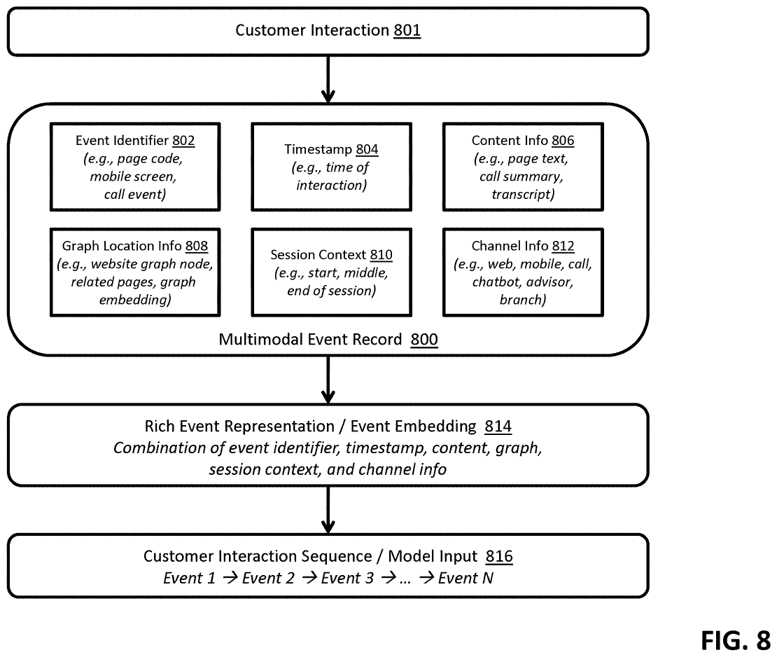

As described in further detail below with respect to FIG. 8, in some embodiments a page visit in a page flow may be represented as a multimodal event record. A multimodal event record may also correspond to another type of customer interaction, such as a mobile application action, call center interaction, chatbot interaction, virtual assistant interaction, advisor interaction, branch service interaction, task completion event, or other digital or communication channel event. By representing customer interactions as multimodal event records, the system may model a customer journey as a sequence of enriched events rather than merely as a sequence of webpage identifiers.

At block 306, the task prediction module 106b trains a machine learning model based on page session data corresponding to each user that is associated with the website 108. For example, the training of the machine learning model may include two stages, in which the training performed in block 306 may be a first stage of the two stages. In another example, the task prediction module 106b may access or obtain a machine learning model from the machine learning store 110. In some embodiments, the machine learning store 110 can store all types of machine learning models, such as classification type machine learning model(s), regression type machine learning model(s), support vector machines (SVM) machine learning model(s), ensemble method machine learning model(s), neural network model(s), recurrent neural network model(s), deep learning model(s), transformer model(s), decoder-only transformer model(s), foundation model(s), generative artificial intelligence model(s), language model(s), or large language model(s).

More specifically, after receiving the page session data from the page sessions database 120, the data retrieval module 106a may transmit the page session data to the task prediction module 106b. In turn, the task prediction module 106b may use the page session data to train the machine learning model. As discussed previously, the page session data may include, for each user session, at least one of a page flow including one or more webpages in sequence, the time in which each webpage of the page flow was accessed, the page identifier (or page code) that corresponds to each webpage, and a source of each webpage.

The machine learning model may, for example, be a language model or a large language model. In some embodiments, the machine learning model or architecture may be of a generative artificial intelligence (AI), such as GPT-family models, transformer-based conversational models, encoder-decoder models, decoder-only language models, retrieval-augmented generation models, domain-specific language models, or other generative artificial intelligence models.

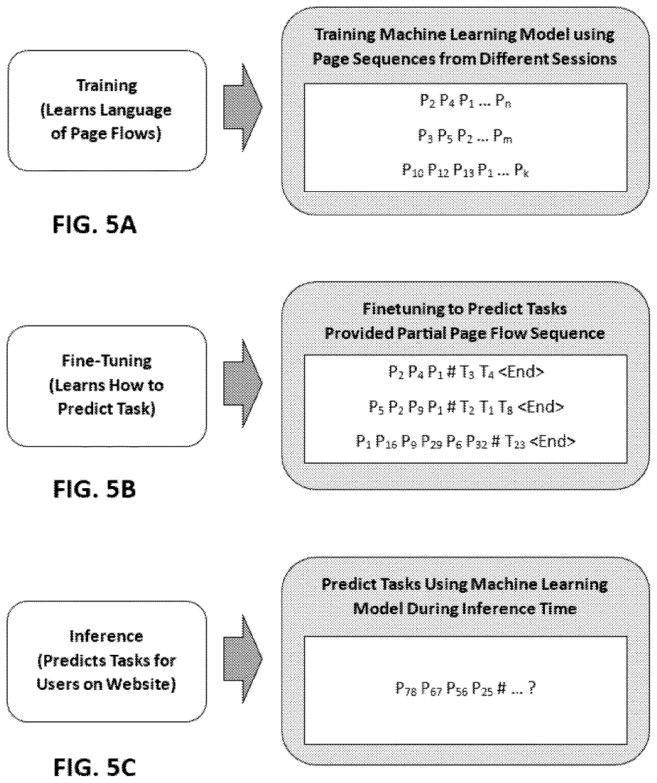

The machine learning model may be trained to learn from the language of the page flows. In other words, each webpage may be analogous to a word. Likewise, a sentence may be analogous to a page flow. Therefore, the machine learning model may attempt to learn how to predict the next webpage (or next webpages) in the page flow (e.g., compared with predicting the next word or words in a sentence) based on such training. For example, as shown in FIG. 5A, there may be multiple page flows (e.g., “P₂, P₄, P₁ . . . Pn,” “P₃, P₅, P₂ . . . Pm,” “P₁₀, P₁₂, P₁₃, P₁ . . . Pk”) that each correspond to a page session of a user session. It should be noted that, in some embodiments, with respect to the page session data, the machine learning model may not necessarily learn from the contents of the webpage (e.g., text, images, audio, video, etc.). Instead, the machine learning model may learn from at least one of the sequence of webpages in the page flow, page identifiers (or page codes), task identifiers (or tasks), the time at which each page was accessed and the source of the webpage. In some embodiments, each of the multiple page flows shown in FIG. 5A may correspond to different users who have accessed the website. In other embodiments, each of the multiple page flows shown in FIG. 5B may correspond to the same user has previously accessed the website. As discussed previously, in some embodiments, the page flows used to train the machine learning model correspond to each (or every) user that has visited or accessed the website 108 at some point (a user may be associated with one or more page sessions). The machine learning model may take a subset of a page flow (e.g., “P₁₀, P₁₂, P₁₃”) and attempt to predict the next immediate (e.g., subsequent) webpage in the sequence (e.g., “P₁”).

To facilitate the learning, the machine learning model (or another software application or system) may, upon receipt of the page session data, convert each webpage of the page flow in the page session data into a webpage token (e.g., lexical token), thus producing a sequence of webpage tokens. Next, the machine learning model determines a page embedding to be associated with each webpage token. The page embeddings may be a multidimensional vector that represents a webpage (e.g., a webpage may be represented by a single row or column vector having fifty numbers as elements of the vector).

In some embodiments, the page embeddings are determined by first generating a random page embedding for each webpage token. Next, for each page flow, the machine learning model attempts to predict the next webpage token in sequence. For example, a page flow may include a predetermined number of webpages (e.g., ten webpages). The machine learning model attempts to predict the next page based on a partial sequence corresponding to a subset of the webpages (e.g., first six webpages). The predicted webpage is compared to the correct webpage (e.g., the seventh webpage) based on a loss function. The current embeddings (and/or weights or model parameters) for the relevant webpages are updated based on the results of the loss function. In some embodiments, the machine learning model uses at least one of the time in which each webpage of the page flow was accessed, the page identifier (or page code) that corresponds to each webpage, and the source of each webpage, to predict the next webpage. The machine learning model goes through such a forementioned process until accurate (finalized) page embeddings (and/or weights or model parameters) are generated. For example, the machine learning model may iterate or loop until it no longer improves its accuracy or when an accuracy threshold is reached (e.g., 95% correct). After such training is performed, the machine learning model may be capable of accurately predicting the next webpage using the finalized page embeddings (and/or weights or model parameters).

In some embodiments, the first-stage training may include pretraining a foundation model using historical customer interaction sequences. The historical customer interaction sequences may include click session data, call summary data, conversation data, mobile activity data, task completion data, or combinations thereof. The system may arrange the historical customer interaction data according to timestamps to generate unified customer interaction sequences.

For example, a unified customer interaction sequence may include a first web session control token, a sequence of webpage tokens corresponding to webpages accessed during a first website session, a second web session control token indicating an end of the first website session, a call initiation control token, natural-language call summary text, a call stop control token, and one or more additional event tokens associated with subsequent website, mobile, advisor, or branch service interactions.

In some embodiments, the foundation model is trained using a causal language modeling objective. For example, the foundation model may be trained to predict a next token, next event, next interaction, next webpage, next call-related token, next task token, or next sequence portion based on prior portions of the unified customer interaction sequence. In some embodiments, the foundation model may learn the language of clicks and conversations by learning temporal relationships between webpage sequences and natural language call summaries.

The foundation model may include a decoder-only transformer model, masked self-attention model, large language model, generative artificial intelligence model, or other sequence model. In some embodiments, the model may be trained from scratch using historical customer interaction sequences. In other embodiments, the model may be initialized from a pre-trained language model and further trained using historical customer interaction sequences.

At block 308, the data retrieval module 106a retrieves user attribute data and user task data. For example, the data retrieval module 106a may transmit a request to the user attributes database 130 to obtain the user attribute data. In response, the user attributes database 130 may transmit the user attribute data to the server computing device 106, where the user attribute data is received by the data retrieval module 106a. It should be noted that, in some embodiments, the user attribute data corresponds to the user (e.g., is personal to the user as opposed to other users). However, it should also be noted that, in some embodiments, the user attributes database 130 may also include user attribute data from other users, but the data retrieval module 106a may retrieve the user attribute data corresponding to the user. As discussed previously, user attribute data may include, but is not limited to, demographics (e.g., age, gender, nationality, ethnicity, religion), employment, income, assets, academic achievements, licenses, physical address, bank accounts, financial accounts (e.g., types of accounts (e.g., individual retirement account (IRA), health spending account (HSA)), total amount in account(s) invested with financial organization, etc.), etc. In some embodiments, the user attribute data is obtained when the user provides personal information (e.g., user attributes) in order to register with the website 108 to obtain a login account.

In another example, the data retrieval module 106a may transmit a request to the user tasks database 140 to obtain the user task data. In response, the user tasks database 140 may transmit the user task data to the server computing device 106, where the user task data is received by the data retrieval module 106a. As discussed previously, the website 108 may allow the user to perform or complete one or more tasks (e.g., purchasing a product, making a transaction, registering for courses at a university, etc.). In some embodiments, a task completion may be detected based on the occurrence of a specific event that is associated with the task (e.g., task event). In other embodiments, a task completion may be detected based on a webpage with which the user is provided (e.g., task of purchasing product is determined to be completed with the user is shown the order confirmation webpage). Consequently, the user task data includes data on each (or every) task that has been completed by the user on the website 108. It should be noted that, in some embodiments, the user task data corresponds to the user (e.g., is personal to the user as opposed to other users). However, it should also be noted that, in some embodiments, the user tasks database 140 may also include user task data from other users, but the data retrieval module 106a may select to retrieve the user task data corresponding to the user.

It should be noted that, one or more webpages of the website 108 may be associated with a task identifier, which identifies a task that is associated with the webpage. For example, a first page of the website 108 (“fid.com/trade/equity/ng/order confirm”) may be mapped to a first task identifier (“T₁”) that is associated with a first task (“purchasing or selling of common stock”). In another example, a second page of the website 108 (“iphone.fid.com/transact/transfer/mmlanding”) may be mapped to a second task identifier (“T₂”) that is associated with a second task (“money movement”). In some embodiments one or more pages of the website 108 may each be associated with one or more tasks. In some embodiments, one or more pages of the website 108 may not be associated with any tasks. A (mapping) machine learning model that is trained to map tasks with a webpage may be used to perform the mapping between the webpages of the website 108 and one or more tasks. Alternatively, a structure mapping engine (SME) may be used to perform the mapping between the webpages of the website 108 and one or more tasks. In some embodiments, task identifiers may be defined according to a channel-agnostic task taxonomy. The channel-agnostic task taxonomy may associate tasks performed through different channels with common task identifiers. For example, a task completed through a website and a corresponding task completed through a call center channel may be mapped to the same task identifier when the tasks correspond to the same user intent or activity. Tasks in the channel-agnostic task taxonomy may be encoded as task tokens, such as T1 through TN, for use in training, fine-tuning, or inference.

At block 310, the task prediction module 106b trains (or fine-tunes) the machine learning model based on past page session data associated with user, user attribute data, and user task data. For example, as discussed previously, the training of the machine learning model may include two stages, in which the training performed in block 310 may be a second stage of the two stages. As discussed previously with respect to block 304, the data retrieval module 106a may retrieve page session data from the page sessions database 120. Since the page session data includes data from each user that has previously accessed the website 108, the page session data naturally includes data associated with the user. Such past page session data (e.g., page session data associated with the user) may be accessible by the task prediction module 106b. In the case that the page session data is no longer stored by the server computing device 106, the data retrieval module 106a may retrieve the page session data from the page sessions database 120 again (in this case, the data retrieval module 106a may select to obtain the page session data associated with the user and not page session data associated with other users).

Further, the page session data (e.g., page flows) may be mapped (e.g., by the data retrieval module 106a or the task prediction module 106b) to the completed tasks in the user task data (e.g., the page flow that is associated with the completion of a user task). An example of such mapping is shown in FIG. 4B, in which each of the previous sessions (e.g., “Session 1,” “Session 2,” “Session 3,” Session 4”) are associated with respective page flows that include one or more webpages identified by their page identifiers or page codes (e.g., “P3→P4→P2→P7→P1,” “P2→P5→P3→P1→P2→P3,” “P7→P4→P1→P2→P3,” “P6→P1→P7→P1→P2”). In turn each page flow is associated with one or more tasks or task identifiers (e.g., “T3, T4,” “T2, T1, T8,” “T3, T6,” “T5, T7, T9”). In some embodiments, after the data retrieval module 106a receives the user attribute data and the user task data, the data retrieval module 106a transmits the user attribute data and the user task data to the task prediction module 106b.

It should be noted that, in some embodiments, with respect to the page session data associated with the user, the machine learning model may not necessarily be fine-tuned from the contents of the webpage (e.g., text, images, audio, video, etc.). Instead, the machine learning model may learn from at least one of the sequence of webpages in the page flow, page identifiers (or page codes), task identifiers (or tasks), the time at which each page was accessed and the source of the webpage.

The training of the task prediction module 106b in block 310 may also be considered to be fine-tuning the machine learning model that has been previously trained in, for example, block 306. The notion of fine-tuning may involve retraining the machine learning model on a specific task or dataset, while allowing the machine learning model to retain its previous expertise (e.g., embedding mappings, weights, model parameters, etc.). By fine-tuning the machine learning model, the machine learning model learns new capabilities as well as increases its accuracy in predictions.

An example of fine-tuning is shown in FIG. 5B, in which the machine learning model is provided partial page flows (e.g., “P₂ P₄ P₁,” “P₅ P₂ P₉ P₁,” “P₁ P₁₆ P₉ P₂₉ P₆ P₃₂”) and is instructed to predict or forecast one or more predicted user tasks based on a corresponding partial page flow. In other words, a partial page flow (e.g., “P₂ P₄ P₁,”), instead of its corresponding complete page flow (e.g., “P₂ P₄ P₁ P₇ P₁₁ P₁,”), may be provided to the machine learning model to assist the machine learning model in predicting a user task with minimal information (e.g., in the form of webpages). This is because, in some embodiments, one of the objectives for fine-tuning the machine learning model may be to have the machine learning model predict the user tasks (e.g., during inference time) well beyond the point in time in which the user is already at the webpage to which the user is to begin or complete the intended user task. In other embodiments, the goal may be to predict the tasks before the user even knows which kind of task that the user wishes to perform. Once the machine learning model generates a prediction (e.g., one or more tasks or task identifiers), the result is compared with the correct user tasks or task identifiers (e.g., “T₃ T₄”, “T₂ T₁ T₈,” “T₂₃”). The machine learning model may update at least one of its webpage embeddings, weights, and model parameters. In some embodiments, the machine learning model may use the task identifiers (which correspond to respective tasks) that are associated with each webpage in the page flow to assist in determining the predicted tasks. Similar to the previous training with respect to block 306, the machine learning model may iterate or loop until it no longer improves its accuracy or when an accuracy threshold is reached (e.g., 95% correct). It should be noted that, in some embodiments, the training process performed on the machine learning model in first and second stages (e.g., blocks 304, 306, 306a, 308, 310, and 310a) may be performed offline (e.g., the machine learning model is trained using pre-collected data without real-time updates). More specifically, the machine learning model may not be available (e.g., at inference time) to perform the tasks associated with blocks 311, 312, 314, 316, and 318 (as explained in detail infra) until the machine learning model is completely trained at block 310 and saved at block 310a. Consequently, after completing the second stage of training at blocks 310 (e.g., fine-tuning the machine learning model) and 310a (e.g., saving the fine-tuned model artifact), the machine learning model may be connected to the corresponding website to predict tasks and display recommended content (based on the predicted tasks) for the user.

In some embodiments, the second-stage training may include fine-tuning the pretrained foundation model to predict one or more future tasks using multimodal training sequences. The multimodal training sequences may include profile attributes, demographic attributes, transaction-related attributes, click sessions, call summaries, conversation data, mobile activity data, and completed task identifiers.

The completed task identifiers may correspond to tasks completed through a plurality of interaction channels. For example, the completed task identifiers may correspond to tasks completed through a website, mobile application, call center, chatbot interface, advisor interaction, branch service interaction, or other channel. In some embodiments, the completed-task identifiers are expressed according to a single channel-agnostic task taxonomy. The channel-agnostic task taxonomy may encode tasks as task tokens, such as T1 through TN.

During fine-tuning, the model may be provided with a training sequence that includes a partial customer interaction sequence and one or more known completed task identifiers. The model may be trained to predict the one or more completed-task identifiers based on the partial customer interaction sequence. In some embodiments, the partial customer interaction sequence excludes at least one event associated with initiating or completing the predicted task. In some embodiments, the partial customer interaction sequence excludes one or more events occurring in a channel in which the predicted task is later completed.

In some embodiments, the model may be fine-tuned to predict multiple future tasks. The predicted tasks may include tasks likely to be completed in the same interaction channel as the partial customer interaction sequence or in a different interaction channel. For example, based on a partial website session and prior call summary data, the model may predict that a user is likely to perform a call center task, mobile application task, advisor service task, or branch service task.

In some embodiments, the system may generate a multimodal input sequence using control tokens, structured-data tokens, webpage tokens, natural-language text, and task tokens. For example, an input sequence may be represented as follows:
[USER_PROFILE] UP1 UP2
[WEB_SESSION_INIT] P1 P2 P3 [WEB_SESSION_STOP]
[CALL_INIT]
summary: Client called to check whether an address was updated.
task: T1
[CALL_STOP]
[WEB_SESSION_INIT] P4 P5 P6 [WEB_SESSION_STOP]
[NEXT_TASK] T5

In this example, [USER_PROFILE] is a control token indicating that one or more user-profile tokens follow. The tokens UP1 and UP2 may represent profile attributes, demographic attributes, account attributes, transaction attributes, customer-segment attributes, or other structured user attributes. The control token [WEB_SESSION_INIT] indicates the beginning of a web session, and [WEB_SESSION_STOP] indicates the end of the web session. The tokens P1 through P6 represent webpage identifiers, page codes, canonicalized URLs, page hashes, internal page references, or other digital-content identifiers. The control token [CALL_INIT] indicates the beginning of call-related data, and [CALL_STOP] indicates the end of call-related data. The call-related data may include natural-language call-summary text and one or more task identifiers associated with the call. The control token [NEXT_TASK] indicates that one or more future task tokens are to be predicted by the model. In some embodiments, during fine-tuning, one or more task tokens may appear after the [NEXT_TASK] control token as ground-truth labels or target tokens. During inference, the input sequence may end with the [NEXT_TASK] control token, and the fine-tuned model may generate or score one or more predicted task tokens following the [NEXT_TASK] control token.

In some embodiments, natural language text included in the multimodal input sequence may be tokenized using a vocabulary of the foundation model. In some embodiments, page identifiers, task identifiers, profile identifiers, channel identifiers, or control tokens may be added to or mapped into a vocabulary used by the foundation model. In some embodiments, control tokens, profile tokens, page tokens, channel tokens, and task tokens may be added to a vocabulary used by the foundation model before pretraining or continual pretraining. In some embodiments, natural language text, such as call summaries, call transcripts, chatbot messages, and conversation logs, may be processed using an existing vocabulary of the foundation model. In some embodiments, known webpage identifiers may be represented using dedicated page tokens that are associated with page embeddings, graph embeddings, or both. In some embodiments, unknown URLs, newly observed URLs, or rare digital-content identifiers may be tokenized using byte-pair encoding, word-piece tokenization, sentence-piece tokenization, character-level tokenization, subword tokenization, hashing, or another tokenization technique. In some embodiments, unknown URL tokens may be processed without corresponding page content embeddings or graph location embeddings, or may be associated with default, inferred, or subsequently generated embeddings.

In another example, a multimodal input sequence may include page-name tags and call-summary text as follows:
[WEB_SESSION_INIT]
WEB|CUSTOMER_SERVICE|CUSTOMER_LOGOUT
WEB|PORTFOLIO|PORTFOLIO_SUMMARY
WEB|CUSTOMER_SERVICE|TRANSFER_MONEY
WEB|MONEY_MOVEMENT|TRANSFER|MOVE_MONEY_BASICS_EFT_OUT
[WEB_SESSION_STOP]
[CALL_INIT]
summary: Customer asked when cash from sold shares would be available to transfer to a bank account.
task: CASH_AVAILABLE_TO_WITHDRAW
[CALL_STOP]

In this example, page name tags provide structured representations of webpages accessed by the user, and the call summary text provides natural language context associated with a subsequent or related call interaction.

At block 311, the task prediction module 106b retrieves the fine-tuned model artifact from the machine learning store 110. This retrieval occurs after an indeterminate period of time has elapsed since completion of the offline fine-tuning phase. At block 312, the session management module 106c determines that a user session has been initiated for the user on the website 108. As discussed previously, a user may be associated with the website 108. In other words, the user may be a visitor to the website (e.g., browsing) or may be registered with the website (e.g., have a login account). As such, whenever the user accesses the website (e.g., by logging into the account or by inputting the corresponding URL or using a hyperlink from another website, such as a search engine), the website 108 may determine that a user session has commenced.

In some embodiments, as shown in FIG. 1, the website 108 may be stored or published in the server computing device 106. As such, the session management module 106c may assist the website 108 in initiating a user session. In other embodiments, the website 108 may be stored in a website server computing device that is a separate device from the server computing device 106. For example, the website server computing device may be disposed at a different location than the server computing device 106. Further, in some embodiments, the website server computing device may be configured to respond to users requesting to access the website 108 on the website server computing device.

At block 314, the session management module 106c monitors the ongoing user session of the user on the website 108. In some embodiments, the session management module 106c generates and/or monitors (or maintains) the ongoing user session data, which may include ongoing page session data. The ongoing page session data may in turn include at least one of an ongoing page flow that indicates the webpages that the user has visited, the time in which the user has accessed such webpages, the page code associated with the webpages (e.g., page code is an identifier that identifies a respective webpage), and the source of the webpages. The ongoing user session may be the current (or continuous) time period in which the user is actively interacting with the website. For example, the session management module 106c may determine whether the user is actively interacting with the website by detecting at least one of activation of graphical control elements on the website, movement of a cursor (e.g., mouse, finger, stylus, etc.), scrolling on the webpage, etc.

The ongoing user session may be over an indefinite time period, in which the user session may end (e.g., expires) after the session management module 106c detects that a session expiration event has occurred. For example, the session expiration event may include events in which the user has logged off his or her account on the website 108 or when the session management module 106c detects that the user has not been actively interacting with the website 108 for a predetermined period of time. In some embodiments, in case that the website 108 is published or stored on the website server computing device (instead of the server computing device 106), the session management module 106c may cooperate with the website server computing device to monitor the ongoing user session.

When monitoring the ongoing user session, the session management module 106c may also store (and continuously update) ongoing page session data (that is associated with the ongoing user session). More specifically, the ongoing page session data may include an incomplete page flow of the webpages to which the user has visited. For example, the incomplete page flow may include one or more webpages that are sequenced according to time. Whenever the user accesses a new webpage, the session management module 106c updates the incomplete page flow (and by extension the ongoing page session data) with the new webpage. In case that the user session ends, the session management module 106c may determine that the incomplete page flow is now complete (e.g., a complete page flow or completed page session data). In such case, the session management module 106c may transmit the page session data to be stored in the page sessions database 120.

It should be noted that the session management module 106c may also be aware of the user accessing the website from more than one location. For example, the user may decide to open a new tab (or a new instance of the web browser) on the same device (e.g., client computing device 102) to the website 108. In another example, the user may decide to access the website from a different device at the same time that the user is still interacting with the website 108 on the original device. In yet another example, the user may switch devices, in which the user moves to a new different device. In the aforementioned examples, the session management module 106c may still consider accessing from different locations to be part of the ongoing user session. As a result, the session management module 106c may continuously update the incomplete page flow based on when (e.g., based on time) the webpages were accessed.

The session management module 106c may perform monitoring of the ongoing page session based on how the user interacts with the website 108. For example, in the case that the user is registered with the website 108 (e.g., is associated with a login account), the session management module 106c may monitor the user session via the user's login session. It should be noted that in cases in which the user is not registered with the website 108, the server computing device 106 may monitor the user session of such unregistered user via the use of cookies that may be stored on the client computing device of the unregistered user. Cookies may be, for example, text files that are stored on the client computing device. Cookies are also capable of tracking a user's browsing behavior (e.g., which webpages that the user has visited on the website) and facilitating user session management (e.g., login information, items in shopping cart, etc.). As such, when the unregistered user accesses the website 108, the server computing device 106 may retrieve the cookie from the client computing device of the unregistered user. It should also be noted that, in some embodiments, the server computing device 106 may also continuously store user data (e.g., page session data) regarding the unregistered user without the use of cookies.

At block 316, the task prediction module 106b determines one or more predicted tasks based on ongoing page session data and user attribute data. It should be noted that, in some embodiments, the one or more predicted tasks may be determined to be tasks that a user is going to perform in the immediate future (e.g., 5-10 minutes), is likely to perform in the immediate future, or may be interested in performing in the immediate future. As discussed previously, in some embodiments, the session management module 106c generates and monitors (or maintains) the ongoing user session data, which may include ongoing page session data. The ongoing page session data may in turn include at least one of an ongoing page flow that indicates the webpages that the user has visited, the time in which the user has accessed such webpages, the page code associated with the webpages (e.g., page code is an identifier that identifies a respective webpage), and the source of the webpages. The ongoing user session may be the current (or continuous) time period in which the user is actively interacting with the website 108. As such, an ongoing page session data may be continuously updated based on the webpages that have been visited by the user.

After a predetermined number of webpages has been visited by the user, the task prediction module 106b determines one or more predicted tasks based on the ongoing page session data and user attribute data. In some embodiments, the task prediction module 106b may determine that the current number of webpages is sufficient to determine one or more predicted tasks. As discussed previously with respect to block 308, the data retrieval module 106a may have previously obtained the user attribute data from the user attributes database 130. As such, the user attribute data may be accessible by the task prediction module 106b (and, by extension, the machine learning model). In the case that the user attribute data is no longer stored by the server computing device 106, the data retrieval module 106a may retrieve the user attribute data from the user attributes database 130 again. An example of such determination of predicted tasks is shown in FIG. 5C, in which the machine learning model uses the current webpages in the ongoing page session (e.g., P₇₈ P₆₇ P₅₆ P₂₅) to predict one or more tasks.

In some embodiments, during inference, the system may generate an input sequence based on an ongoing interaction associated with a user. The input sequence may include a partial current click session, one or more previous click sessions, customer profile attributes, demographic attributes, transaction-related attributes, prior call summaries, current call summary information, conversation data, mobile activity data, advisor-interaction data, branch service data, or other available modalities.

In some embodiments, the input sequence may include available modalities and may omit unavailable modalities. In some embodiments, unavailable modalities may be represented using a null token, mask token, absence indicator, or other token indicating that a modality is unavailable for the user or interaction. In this manner, the same foundation model may process input sequences having different combinations of available modalities.

The fine-tuned foundation model may process the input sequence and output one or more predicted task tokens. The predicted task tokens may correspond to tasks likely to be performed in the same channel as the ongoing interaction or in a different channel. For example, the model may predict, based on a current website session, that the user is likely to perform a call-center task. In another example, the model may predict, based on a prior call summary and a current website session, that the user is likely to perform a mobile application task, advisor service task, or branch service task.

In some embodiments, the predicted task tokens may be ranked according to likelihood. For example, the model may output a top-N set of predicted tasks, such as a top-three set of predicted tasks. In some embodiments, the predicted tasks may correspond to tasks likely to be performed during a near-term time window, before completion of a current task, before initiation of a subsequent task, or before the user expressly requests assistance with the task.

At block 318, the webpage management module 106d displays recommended content based on the one or more predicted tasks. More specifically, the task prediction module 106b or the webpage management module 106d may generate or determine recommended content based on the one or more predicted tasks. For example, the webpage management module 106d may modify a webpage currently accessed by a user by rearranging one or more existing content items on the webpage to accommodate the one or more recommended content items. More specifically, the webpage may include preexisting content items (e.g., text, images, graphical control elements, etc.). As discussed previously, a graphical control element may be a component on the webpage with which the user is capable of interacting. For example, a graphical control element may include at least one of a button, widget, and icon. For example, the button may include a hyperlink (e.g., in the form of a uniform resource locator (URL)) that, when activated, causes the user to be taken to another webpage of the same or different website. A graphical control element may also include at least one of text fields (e.g., for inputting texts to, for example, search on a search engine), and option selectors (e.g., checkboxes, radio buttons, drop-down lists, sliders). Consequently, the webpage management module 106d may modify the webpage by rearranging the preexisting content items (e.g., text, images, graphical control elements, etc.) to accommodate the recommended content. Such rearrangement may include physically moving one or more of the preexisting content items to, for example, the top of the webpage, the sides of the webpage, or the bottom of the webpage and disposing the recommended content in the middle of the webpage. In another example, the rearrangement may include interweaving the recommended content with the one or more preexisting content items.

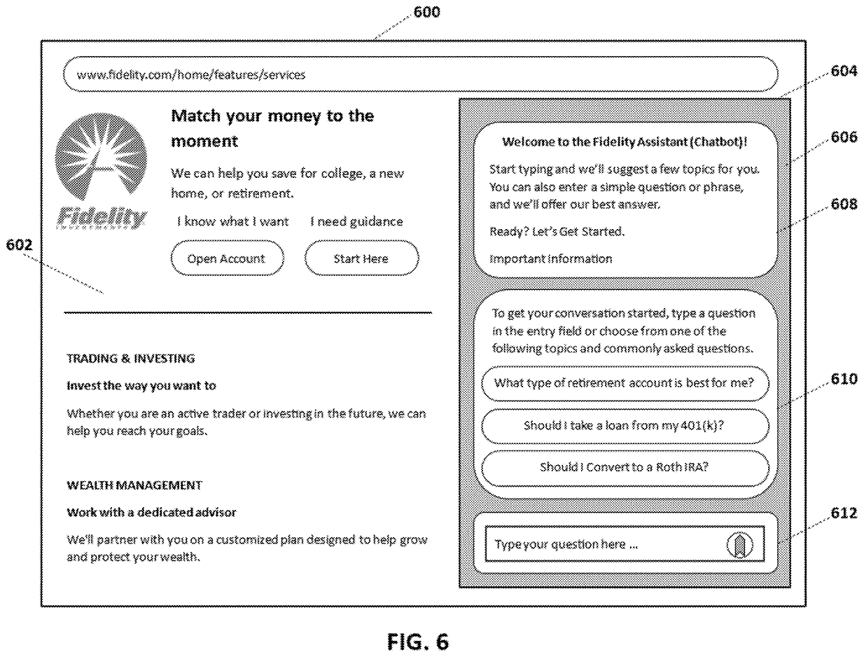

Another example of such recommended content is shown in FIG. 6, in which a webpage (e.g., “www.fidelity.com/home/features/services”), currently accessed by the user (e.g., webpage 600), includes a chatbot 606 that may be accessed by the user. For example, the user may be in need of assistance in navigating the website 108, and therefore may access a chatbot 606 that is a feature of the current webpage 600. As discussed previously, a chatbot, may be a software application or web interface that is configured to simulate human conversation through text or voice interactions. As shown in FIG. 6, the current webpage 600 may include a first section 602 and a second section 604, in which contents of the webpage are disposed in the first section 602 and the chatbot 606 is disposed in the second section 604. The chatbot 606 may operate using a machine learning model, such as a language model or a large language model (LLM) or may operate using a generative artificial intelligence (AI) model. Further, the chatbot may include an output section 608 and an input section 612, in which the user may input text (e.g., a question) into the input section 612 and may receive a response from the chatbot in the output section 608. For example, the chatbot 606 may be a guide or virtual assistance that assists users in navigating the website or providing answers to questions that users have regarding the different tasks that the user is capable of performing on the website. In some embodiments, the chatbot 606 is capable of continuing the conversation with the user even if the user has moved to another webpage within the same website 108.

As shown, the chatbot 606 includes a recommended content section 610, which is the location in which the webpage management module 106d displays the recommended content (that was determined based on the one or more predicted tasks). In the example shown in FIG. 6, the recommended content is in the form of recommended questions (or queries) for the user. In some embodiments, a recommendation machine learning model (which may include a language model or large language model) may generate or extract the recommended content (e.g., recommended questions or queries) for the user based on the one or more predicted tasks. In this case, the machine learning model may have determined a first predicted task (e.g., user wishes to open up a retirement account), a second predicted task (e.g., user is in need of money), and a third predicted task (e.g., user is wondering how to modify his or her financial account after moving to a state that has no state income tax).

As a result, the recommendation machine learning model may generate based on (or extract from) the first predicted task, the second predicted task, and the third predicted task, a first recommended question (e.g., “What type of retirement account is best for me?”), a second recommended question (e.g., “Should I take a loan from my 401(k)?”), and a third recommended question (“Should I Convert to a Roth IRA?”). As such, the webpage management module 106d may display the recommended question or query (which was generated by the recommendation machine learning model based on the one or more predicted tasks that were generated by the machine learning model) on the chatbot 606 to be viewed by the user. It should be noted that by activating one of the first recommended question, second recommended question, or third recommended question may be considered an input by the user. As such, the proper response may be displayed in the output section 608. It should further be noted that the recommended content shown in the recommended content section 610 may be personalized for each user that visits the website. As such, one user may have recommended content that is different from another user. It should be noted that, in some embodiments, the webpage management module 106d may modify the webpage to display the recommended content. For example, the webpage may be modified to re-rank content (news, articles, widgets, etc.) based on the task predictions. The routine ends at block 320.

In some embodiments, the recommended content generated based on the one or more predicted tasks may include a recommended output associated with a channel other than a currently accessed website page. For example, the recommended output may include a recommended experience, content item, product, chatbot prompt, virtual assistant starter question, service routing action, branch service recommendation, advisor service recommendation, or next-best-action recommendation.

In some embodiments, a recommendation module may map predicted task identifiers to corresponding recommended outputs. For example, if a predicted task corresponds to a stock-trading task, the recommendation module may retrieve or generate a trading-related widget, educational article, product recommendation, chatbot prompt, or workflow shortcut. If a predicted task corresponds to a beneficiary update task, the recommendation module may retrieve or generate a beneficiary update form, guided workflow, service routing instruction, virtual assistant prompt, or branch service preparation item.

In some embodiments, the recommended output may be displayed to the user through a website, mobile application, chatbot interface, virtual assistant interface, or other user interface. In some embodiments, the recommended output may be displayed to an employee, representative, advisor, or service associate through an internal interface. For example, a branch service interface may display one or more tasks that the user is predicted to be interested in before or during a branch interaction.

In some embodiments, the recommended output may be generated independently of an explicit user approval to create a task record. For example, the system may predict a task and display a recommended output before the user selects a task, submits a task request, calls a representative, or otherwise expressly initiates the task.

It should be noted that the task prediction module 106b may continuously train the machine learning model based on trend data. More specifically, there may be one or more trends that are observed with respect to completing tasks by other users. The trend data may be based on one or more completed tasks that have been completed by other users. Further, each completed task may be associated with one or more webpages. A trend may be observed when a large number of users (e.g., 30% or higher) completes the same (or similar) task with the same or similar set of webpages accessed. For example, the observed trend data may indicate that users (e.g., such as a large number of users) are more likely to perform one or more specific tasks (e.g., “T3”, “T17”) based on a particular sequence of webpages in a page flow (e.g., “P16”, “P37”, “P2”). Further, such trend data (associated with such one or more trends) may be stored in the user tasks database 140. As such, the data retrieval module 106c may, for example, periodically (over a predetermined time interval) retrieve trend data from the user tasks database 140. In some embodiments, the user tasks database 140 may transmit the trend data automatically at a predetermined time intervals or when there is a new trend observed. As such, the task prediction module 106b may train or fine-tune such machine learning model based on the trend data. As a result of such training, the machine learning model may determine predicted tasks based at least one of the ongoing page session data (corresponding to the ongoing page session), the user attribute data, and the trend data. In some embodiments, trend data may be generated for multimodal event sequences, such that the trend data identifies recurring combinations of web activity, call summaries, mobile interactions, profile attributes, or completed task identifiers that are associated with later task completion.

It should be also noted that, in some embodiments, blocks 314, 316, and 318 may be continuously performed (e.g., the routine 300 loops back to block 314 from block 318) until the user session ends or expires. This is because the user may perform multiple tasks on the website 108, and the machine learning model may attempt to predict each task that the user performs. More specifically, the user may access a set of webpages during the user session. The set of webpages may be divided into page intervals that each include a predetermined number of webpages that are sequenced according to a time in which each of the predetermined number of webpages were accessed by the user. The machine learning model determines at least one predicted task at the end of each page interval.

In some embodiments, a predicted task is determined by the machine learning model based at least in part on each webpage that has been accessed cumulatively by the user since the beginning of the user session (e.g., every webpage that was accessed since the first webpage in the page flow). In other embodiments, the predicted task is determined by the machine learning model based at least in part on each webpage that has been accessed by the user in a current page interval. In other words, the machine learning model may wait until the user accesses or visits a predetermined number of webpages to generate another set of one or more tasks (e.g., the machine learning model predicts a first set of tasks after the user visits a first set of five webpages, then the machine learning model predicts a second set of tasks based on a second set of five webpages (visited immediately and/or subsequently by the user after the first set of five webpages), but not based on the first set of five pages).

In further embodiments, the predicted task is determined by the machine learning model based at least in part on a subset of the webpages that have been accessed by the user in a current page interval. In other words, the machine learning model may first wait until the user accesses or visits a predetermined number of webpages to generate another set of one or more tasks. Then the machine learning model determines the predicted task based on a subset of the webpages corresponding to the predetermined number of pages (e.g., the machine learning model predicts a set of tasks after the user visits ten webpages, but the prediction is made on six webpages of the ten webpages). In other embodiments, it may be possible that the machine learning model incorrectly predicted the incorrect tasks for the user. As such, the machine learning model may continuously attempt to predict the correct tasks with each webpage (or predetermined number of webpages) that the user accesses during the user session.

In yet another embodiment, the predicted task is determined based on at least in part on a first set of accessed webpages (e.g., the first set of accessed webpages including one or more accessed webpages) that have been accessed by the user in a predetermined time period. In other words, the machine learning model may first wait until a predetermined time period has passed (e.g., 1 minute, 10 minutes, 15 minutes, 20 minutes, etc.). Next, the machine learning model may, in real-time extract or receive one or more accessed webpages that correspond to the predetermined time period (thereby forming the first set of accessed webpages). For example, real-time may correspond to an action that is performed within milliseconds so that result of such actions is available virtually immediately (e.g., within milliseconds). In this case, the machine learning model is capable of extracting (or receiving) the one or more accessed webpages milliseconds after the predetermined time period has ended. After obtaining the one or more accessed webpages, the machine learning model predicts a set of tasks based on the first set of accessed webpages.

In yet a further embodiment, the predicted task is determined based on at least in part on a second set of accessed webpages which may be a subset of the first set of accessed webpages. For example, the first set of accessed webpages may include eleven webpages (e.g., P1, P2, . . . , P10, P11; sequenced according to time accessed, from earliest to latest) that have been accessed within a time period of ten minutes. As such, the second set of accessed webpages may be a predetermined number of accessed webpages of the first set of accessed webpages. For example, the second set of accessed webpages may include five of the eleven accessed webpages of the first set of accessed webpages. In a further example, each of the accessed webpages in the first set of accessed webpages may be ordered sequentially based on time (e.g., when the user accessed each of the accessed webpages). Consequently, the five accessed webpages in the second set of accessed webpages may correspond to the last (e.g., most recent) accessed webpages (when sequenced according to time from earliest to latest) in first set of accessed webpages (e.g., P7, P8, P9, P10, P11).

In some embodiments, the intervals described above may be event intervals rather than page intervals. For example, an event interval may include a predetermined number of multimodal event records, a predetermined time window of multimodal event records, or a subset of multimodal event records selected from an ongoing interaction sequence. The model may predict one or more tasks after each event interval based on cumulative events, events within the current interval, a most recent subset of events, or events from selected channels or modalities.

It should be further noted that, in one example implementation, the machine learning model in the present disclosure outperforms a conventional machine learning model that uses the classification approach to forecast user tasks. For example, the machine learning model was able to predict at least one task that was eventually performed by the user, 80% of the time. In contrast, the conventional machine learning model predicted at least one task that was eventually performed by the user, 48% of the time. In another example, the machine learning model was able to predict all tasks that were eventually performed by the user 48% of the time.

In contrast, the conventional machine learning model predicted all tasks that were eventually performed by the user, 9% of the time. In a further example, the machine learning model was able to predict at least one task that was in the minority class, 38% of the time. In contrast, the conventional machine learning model predicted at least one task that was in the minority class 0.6% of the time. In yet another example, the percentage of all actual tasks predicted by the machine learning model was 64% of the time. In contrast, the percentage of all actual tasks predicted by the conventional machine learning model was 27% of the time.

### Execution Environment

FIG. 7 illustrates components of an example computing device 700 configured to implement the functionality described herein.

In some embodiments, the computing device 700 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the computing device 700 may be implemented as web services consumables via one or more communication networks. In further embodiments, the computing device 700 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 700 may include one or more processors 702, such as physical central processing units (“CPUs”); one or more network interfaces 704, such as network interface cards (“NICs”); one or more computer readable medium drives 706, such as a high density disk (“HDDs”), solid state drives (“SSDs”), flash drives, and/or other persistent computer readable media; one or more input/output drive interfaces 708; and one or more computer-readable memories 710, such as random access memory (“RAM”) and/or other volatile non-transitory readable media.

The one or more computer-readable memories 710 may include computer program instructions that one or more computer processors 702 execute and/or data that the one or more computer processors 702 use in order to implement one or more embodiments. For example, the one or more computer-readable memories 710 can store an operating system 712 to provide general administration of the computing device 700. As another example, the one or more computer-readable memories 710 can store a data retrieval module 714 (e.g., data retrieval module 106a) for retrieving data from one or more databases. In a further example, the one or more computer-readable memories 710 can store a task prediction module 716 (e.g., task prediction module 106b) for determining one or more predicted tasks. In yet another example, the one or more computer-readable memories 710 can store a session management module 718 (e.g., session management module 106c), which manages (or monitors) a user session on a website (e.g., website 722 or website 108).

In yet a further example, the one or more computer-readable memories 710 can store a webpage management module 720 (e.g., webpage management module 106d), which may generate and display recommended content based on one or more predicted tasks generated by the task prediction module 716 (e.g., task prediction module 106b). In a further example, the one or more computer-readable memories 710 can store a website 722 (e.g., website 108), which may include one or more webpages that are accessible via a uniform resource locator (URL). In another example, the one or more computer-readable memories 710 can store one or more machine learning models 724, including language models, large language models, transformer models, decoder-only transformer models, foundation models, generative artificial intelligence models, or combinations thereof, for processing natural language input, multimodal event records, customer interaction sequences, and generating natural language output, task token output, intent token output, or recommendation output for processing natural language input and generating natural language output (e.g., machine learning store 110). In yet another example, the one or more computer-readable memories 710 can store machine learning model(s) other than a language model or a large language model (e.g., models stored or included in (large) language model(s) 724), such as classification type machine learning model(s), regression type machine learning model(s), support vector machines (SVM) machine learning model(s), ensemble method machine learning model(s), neural network model(s), recurrent neural networks (e.g., long short term memory), deep learning model(s).

### Multimodal Event Records

As mentioned above, the systems and methods described herein may process customer interactions across multiple channels and modalities, rather than processing only a sequence of webpage identifiers. To support such processing, individual customer interactions may be represented as enriched multimodal event records that preserve contextual information available at or near the time of each interaction.

FIG. 8 is an example diagram illustrating a multimodal event record 800, according to some embodiments. As shown in FIG. 8, a customer interaction 801 may be represented as the multimodal event record 800. The customer interaction 801 may correspond to a webpage visit, mobile application interaction, call center interaction, chatbot interaction, advisor interaction, branch service interaction, task-completion event, or other digital or communication channel interaction.

The multimodal event record 800 may include a plurality of event dimensions associated with the customer interaction 801. For example, the multimodal event record 800 may include an event identifier 802, a timestamp 804, content information 806, graph-location information 808, session-context information 810, and channel information 812.

The event identifier 802 may identify the particular interaction represented by the multimodal event record 800. For example, the event identifier 802 may include a page code, page name, URL, canonicalized URL, page hash, mobile screen identifier, call event identifier, chatbot interaction identifier, advisor interaction identifier, branch-service interaction identifier, or other identifier associated with the customer interaction 801.

The timestamp 804 may indicate a time associated with the customer interaction 801. For example, the timestamp 804 may indicate when a webpage was accessed, when a mobile screen was viewed, when a call occurred, when a chatbot message was received, when an advisor interaction occurred, or when a task-completion event occurred. In some embodiments, the timestamp 804 may be used to arrange multiple multimodal event records 800 into a temporal customer interaction sequence.

The content information 806 may include information describing content associated with the customer interaction 801. For example, the content information 806 may include page text, page metadata, page title information, page topic information, call summary text, call transcript text, chatbot message text, advisor notes, branch service notes, or other semantic information associated with the interaction. In some embodiments, the content information 806 may include or be used to generate a content embedding.

The graph location information 808 may indicate a location of the customer interaction 801 within a graph structure. For example, for a webpage interaction, the graph location information 808 may indicate a location of the webpage within a website graph, navigation graph, content graph, or other digital-asset graph. The graph-location information 808 may include a graph node, related pages, adjacency information, graph embeddings, node embeddings, or other graph-based features. In some embodiments, the graph location information 808 may identify webpages, mobile screens, content items, tasks, or service flows that are related to the customer interaction 801.

The session context information 810 may indicate a context of the customer interaction 801 within a session or customer journey. For example, the session context information 810 may indicate whether the interaction occurred near a beginning, middle, or end of a session. The session context information 810 may also include a session identifier, number of prior interactions in the session, elapsed time since a prior interaction, duration of the session, or information indicating whether the customer interaction 801 is associated with task initiation, task continuation, or task completion.

The channel information 812 may identify a channel associated with the customer interaction 801. For example, the channel information 812 may indicate that the customer interaction 801 occurred through a website, mobile application, call center, chatbot, advisor channel, branch service channel, or other digital or communication channel. In some embodiments, the channel information 812 may be encoded as a channel token or channel embedding.

As further shown in FIG. 8, the system may generate a rich event representation or event embedding 814 based on the multimodal event record 800. The rich event representation or event embedding 814 may be generated based on a combination of the event identifier 802, timestamp 804, content information 806, graph location information 808, session context information 810, and channel information 812. For example, the system may generate separate embeddings corresponding to one or more of the event dimensions and combine the embeddings to generate the rich event representation or event embedding 814.

In some embodiments, the rich event representation or event embedding 814 may be generated by projecting modality-specific embeddings into a common embedding space and combining the projected embeddings. For example, the system may combine a token embedding associated with the event identifier 802, a temporal embedding associated with the timestamp 804, a content embedding associated with the content information 806, a graph embedding associated with the graph location information 808, a session context embedding associated with the session-context information 810, and a channel embedding associated with the channel information 812. The embeddings may be combined using weighted pooling, attention-based pooling, concatenation followed by projection, summation, averaging, or another embedding combination operation.

In some embodiments, the system may generate the rich event representation or event embedding 814 by applying respective projection layers to different modality-specific embeddings. For example, a first projection layer may project a user profile embedding into the common embedding space, a second projection layer may project a page content embedding into the common embedding space, and a third projection layer may project a page node or graph location embedding into the common embedding space. The projected embeddings may be combined using learned or predefined weights, such as a first weight corresponding to the user profile embedding, a second weight corresponding to the page content embedding, and a third weight corresponding to the page node or graph location embedding. In some embodiments, the weights may be learned during pretraining or fine-tuning.

In some embodiments, data from different modalities may be encoded using modality-specific encoders before being combined into an event embedding. For example, user profile or other tabular data may be encoded using a tabular data encoder to generate a user profile embedding, page content data or call summary text may be encoded using a language model embedder to generate a content embedding, and website graph data may be encoded using a graph embedding model, such as a Node2Vec model or graph neural network, to generate a page node or graph location embedding. The modality-specific embeddings may be projected into a common embedding space and combined using learned weights to generate a final pooled event embedding.

The rich event representation or event embedding 814 may be included in a customer interaction sequence or model input 816. The customer interaction sequence or model input 816 may include a plurality of events arranged in temporal order, such as Event 1, Event 2, Event 3, through Event N. In some embodiments, each event in the customer interaction sequence or model input 816 may be represented by a corresponding rich event representation or event embedding. In this manner, the system may model a customer journey as a sequence of enriched multimodal events rather than merely as a sequence of page identifiers.

The customer interaction sequence or model input 816 may be provided to a machine learning model, language model, large language model, transformer model, foundation model, or other sequence model. The model may process the customer interaction sequence or model input 816 to predict one or more tasks, intents, or activities associated with a user. For example, the model may predict a future task based on a sequence of rich event representations that includes website events, mobile events, call center events, chatbot events, advisor events, branch service events, or combinations thereof.

In some embodiments, a sequence of rich event representations may be provided to one or more transformer layers. The transformer layers may generate contextualized event representations in which each event representation is updated based on preceding events, subsequent events, or both, depending on the model architecture. In some embodiments, a prediction head may generate a label, task token, intent token, or probability distribution for one or more event positions in the sequence. For example, the model may generate a predicted task token at a final event position, at a [NEXT_TASK] token position, or at multiple event positions in the customer interaction sequence.

### Unified Customer Interaction Sequences—Pretraining, Fine-tuning, and Inference

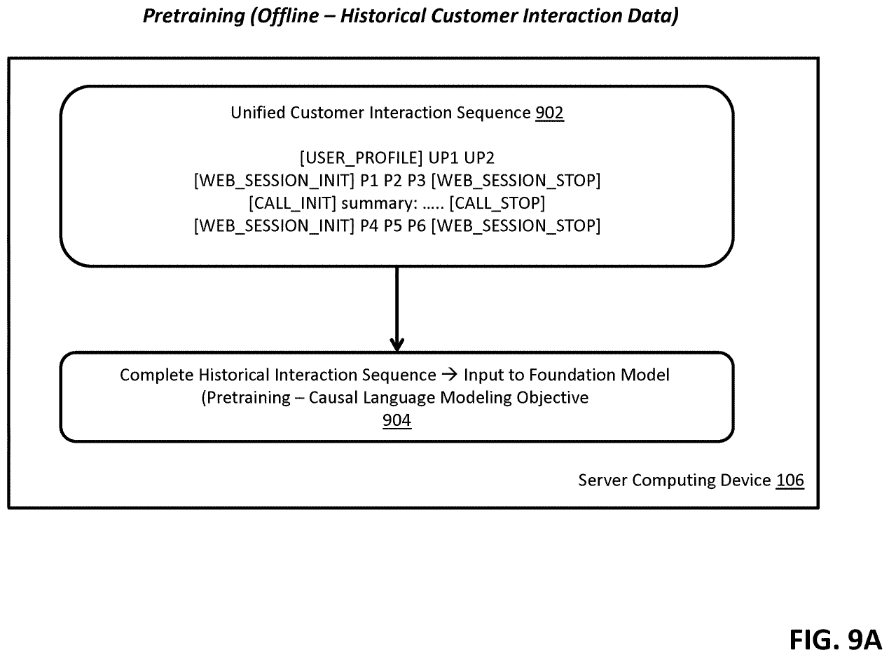

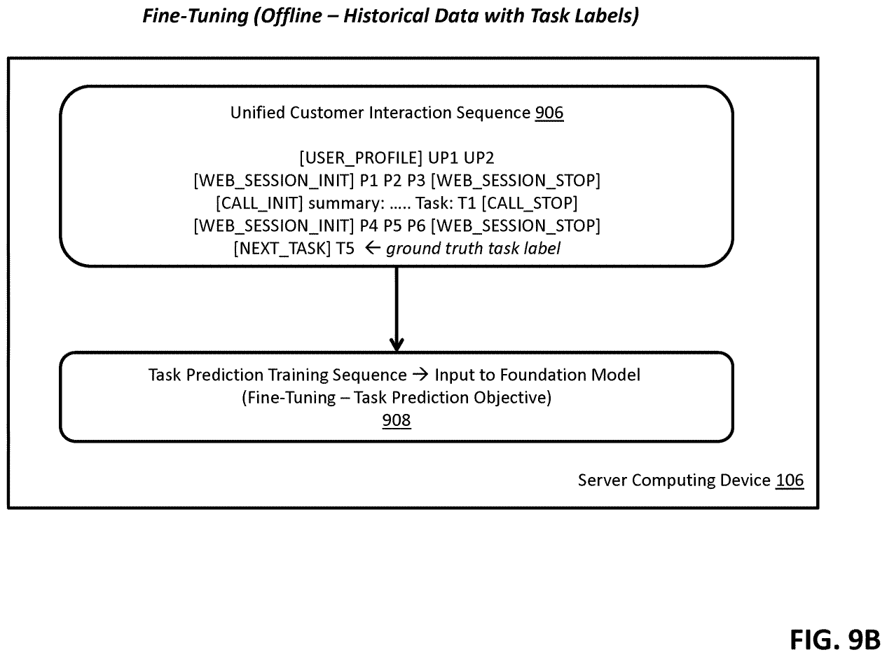

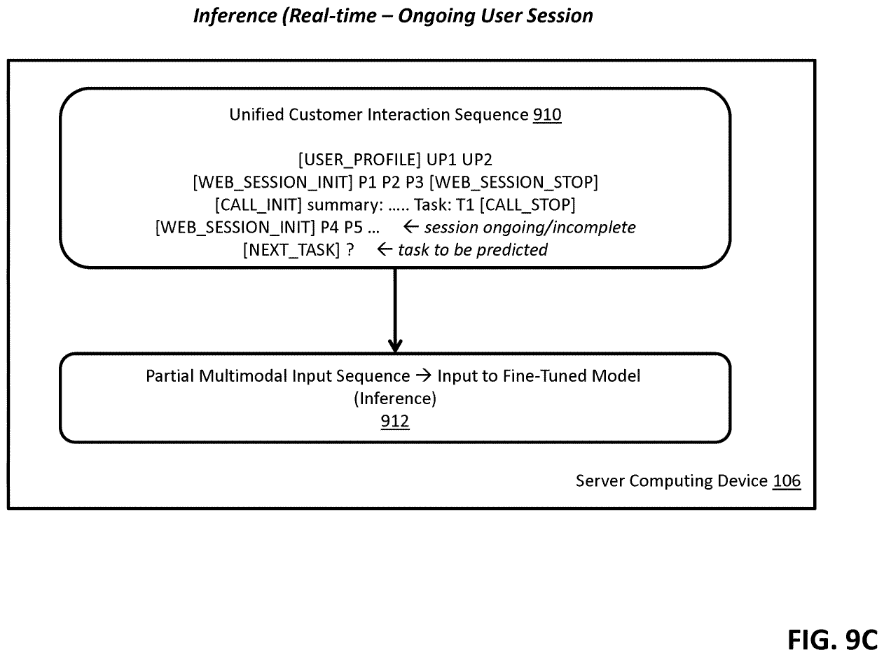

As discussed above, the system may represent individual customer interactions as multimodal event records and may use those records, together with other user-context data, to form a model input sequence. FIGS. 9A, 9B, and 9C are example diagrams illustrating generation of unified customer interaction sequences across three distinct stages—offline pretraining, offline fine-tuning, and real-time inference—according to some embodiments. As described in further detail below, the sequence structure, token content, and model context differ across each stage. In particular, task prediction tokens are used only during fine-tuning and inference, and not during pretraining, and the model that receives the input sequence is a foundation model being trained in the pretraining and fine-tuning stages and a deployed fine-tuned model in the inference stage.

FIG. 9A illustrates generation of a unified customer interaction sequence 902 for use during offline pretraining of a foundation model. As shown in FIG. 9A, the server computing device 106 and data retrieval module 106a may retrieve and process multiple types of historical customer interaction data to construct the unified customer interaction sequence 902. The historical customer interaction data may include user profile data, web session data, call interaction data, and other interaction data as described herein. Although FIG. 9A illustrates selected example data types, it should be appreciated that additional or alternative data types may be used, including mobile application interaction data, chatbot interaction data, advisor interaction data, branch service interaction data, transaction data, conversation log data, or other customer interaction data.

As shown in FIG. 9A, the unified customer interaction sequence 902 may include user profile data associated with a user. The user profile data may include one or more profile attributes, such as demographic attributes, account attributes, asset attributes, transaction attributes, customer segment attributes, or other structured user attributes. In some embodiments, the user profile data may be represented in the unified customer interaction sequence 902 using a user profile control token, such as [USER_PROFILE], followed by one or more user profile tokens, such as UP1 and UP2. The user profile tokens may represent structured attributes associated with the user and may be retrieved from the user attributes database 130 or another user data source.

The unified customer interaction sequence 902 may further include web session data corresponding to one or more web sessions associated with the user. For example, as shown in FIG. 9A, the unified customer interaction sequence 902 may include a first web session represented by a web session initiation control token [WEB_SESSION_INIT], followed by one or more webpage tokens such as P1, P2, and P3, and a web session stop control token [WEB_SESSION_STOP]. The unified customer interaction sequence 902 may further include a second web session represented by a web session initiation control token [WEB_SESSION_INIT], followed by one or more webpage tokens such as P4, P5, and P6, and a web session stop control token [WEB_SESSION_STOP]. The webpage tokens may represent webpage identifiers, page codes, URLs, canonicalized URLs, page hashes, internal page references, or other digital content identifiers associated with webpages accessed by the user during the respective web sessions. In some embodiments, the unified customer interaction sequence 902 may include additional web sessions, fewer web sessions, or web sessions having different numbers of webpage tokens, depending on the historical interaction data available for a given user.

The unified customer interaction sequence 902 may further include call interaction data associated with one or more call center interactions, voice interactions, or other communication channel interactions involving the user. For example, as shown in FIG. 9A, the unified customer interaction sequence 902 may include a call initiation control token [CALL_INIT], followed by call summary text, and a call stop control token [CALL_STOP]. The call summary text may include a natural language description of issues raised by the user, resolutions provided to the user, or other information associated with the call interaction. In some embodiments, all or a portion of the call interaction data may be stored in the call summaries database 125. In FIG. 9A, the call interaction data is represented without task identifiers, as all tokens in the pretraining sequence are treated equivalently under the causal language modeling objective rather than as supervised task labels. Accordingly, any task-related information associated with a call interaction during pretraining is treated as a regular sequence token to be predicted, rather than as a ground-truth label used to supervise task prediction. This is in contrast to the fine-tuning sequence shown in FIG. 9B, in which task identifiers appearing within call interaction data form part of the contextual input used to train the model to predict future tasks.

In some embodiments, the unified customer interaction sequence 902 may further include additional interaction data associated with other channels or modalities. For example, the unified customer interaction sequence 902 may include mobile application interaction data, chatbot interaction data, advisor interaction data, branch service interaction data, transaction data, conversation log data, or other customer interaction data. Each additional interaction type may be represented using corresponding control tokens and data tokens, as described herein with respect to FIG. 8. The unified customer interaction sequence 902 used during pretraining may include interaction data from any number of channels and modalities, provided that the data is derived from historical customer interactions and arranged according to a temporal order of the corresponding interactions.

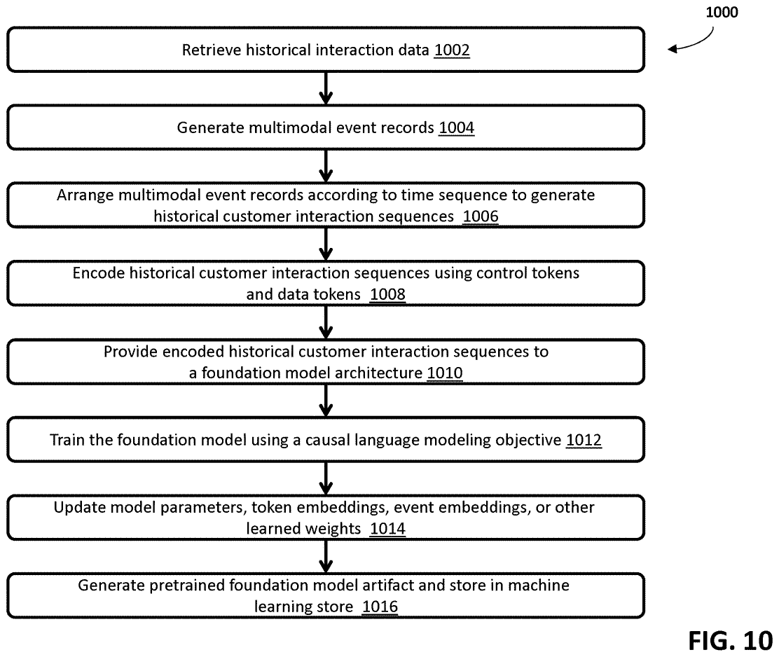

The server computing device 106 may generate the unified customer interaction sequence 902 by arranging historical interaction data associated with multiple channels and modalities into a common sequence format, ordered according to the timestamps of the respective interactions. For example, the unified customer interaction sequence 902 shown in FIG. 9A includes user profile tokens, followed by tokens representing a first web session, followed by tokens representing a call interaction, followed by tokens representing a second web session, arranged in temporal order. In other embodiments, one or more portions of the unified customer interaction sequence 902 may be arranged according to session order, channel order, event order, or another ordering suitable for pretraining. The unified customer interaction sequence 902 is provided as model input 904 to the foundation model during offline pretraining, as described in further detail with respect to FIG. 10. The foundation model is trained using a causal language modeling objective to learn temporal, contextual, and cross-channel relationships among the interaction events represented in the sequence, without the use of task prediction tokens or a task prediction objective at this stage.

As shown in FIG. 9A, the unified customer interaction sequence 902 used during pretraining may include control tokens and data tokens. Control tokens may identify the type or boundary of data included in the sequence. For example, [USER_PROFILE] may identify profile-related data, [WEB_SESSION_INIT] and [WEB_SESSION_STOP] may identify a beginning and end of a web session, and [CALL_INIT] and [CALL_STOP] may identify a beginning and end of call-related data. Data tokens may include profile tokens, webpage tokens, natural language tokens, or other tokens representing customer interaction data.

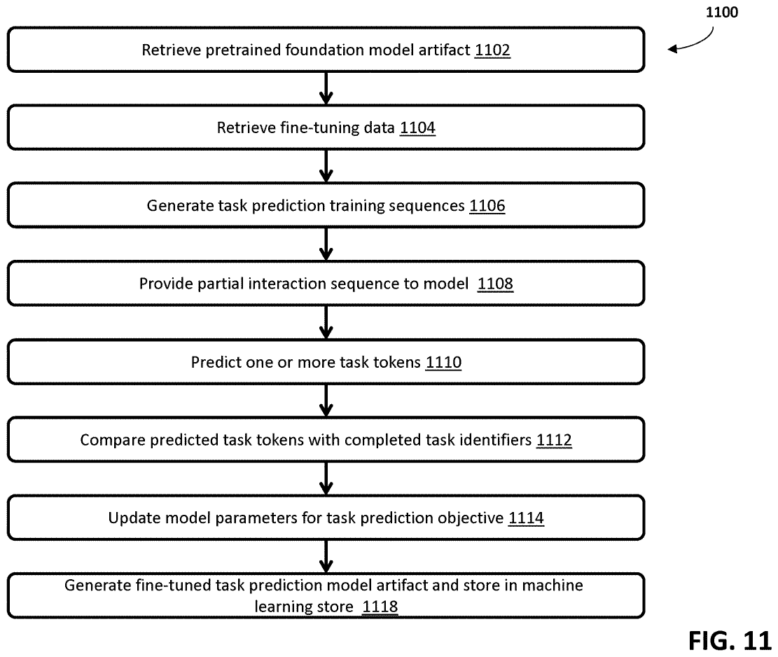

FIG. 9B illustrates generation of a task prediction training sequence 906 for use during offline fine-tuning of the foundation model. As shown in FIG. 9B, the server computing device 106 and task prediction module 106b construct a task prediction training sequence 906 that includes the same profile tokens, web session tokens, and call interaction tokens as the pretraining sequence, but additionally includes a next-task control token [NEXT_TASK] followed by one or more ground-truth task tokens representing tasks completed by the user. For example, as shown in FIG. 9B, the task prediction training sequence 906 may include [USER_PROFILE] UP1 UP2, a first web session, call interaction data including a task identifier T1, a second web session, and [NEXT_TASK] T5, where T5 represents a ground-truth task label used to train the model to predict future tasks. The [NEXT_TASK] control token is used only during fine-tuning and inference, and is not present in the pretraining sequence shown in FIG. 9A. The task prediction training sequence 906 is provided as input 908 to the foundation model under a task prediction objective, as described in further detail with respect to FIG. 11.

As shown in FIG. 9B, the task prediction training sequence 906 is provided as model input 908 to the foundation model during offline fine-tuning. During fine-tuning, the model learns to predict one or more task tokens following the [NEXT_TASK] control token based on a partial customer interaction sequence. The [NEXT_TASK] control token and the ground-truth task tokens that follow it are present only in fine-tuning and inference sequences, and are not present in pretraining sequences.

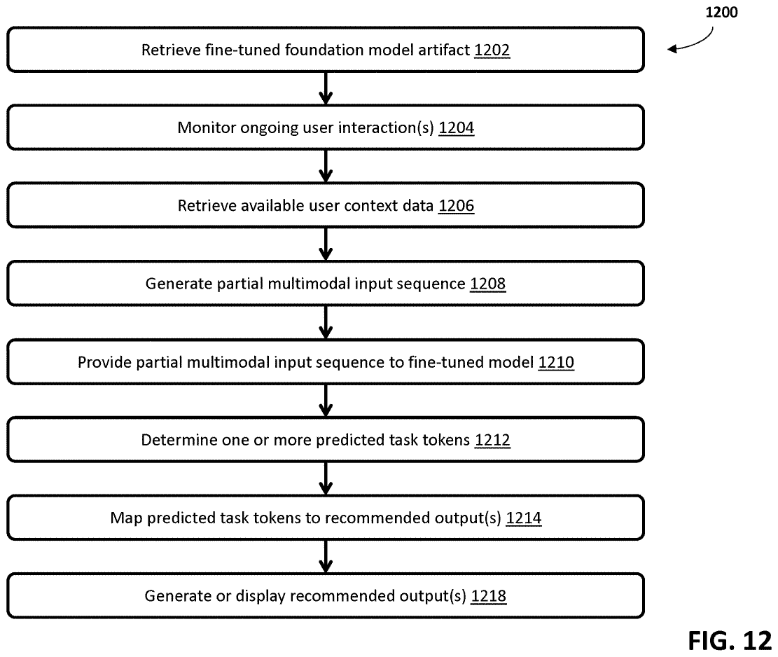

As shown in FIG. 9C, during real-time inference, the fine-tuned model—which has been pretrained and fine-tuned offline and deployed for production use—receives a partial multimodal input sequence 910 as model input 912. The partial multimodal input sequence 910 may include user profile tokens, one or more prior completed interaction sessions, and a partial ongoing web session that has not yet concluded, as indicated by the absence of a [WEB_SESSION_STOP] token for the current session. The partial multimodal input sequence 910 ends with the [NEXT_TASK] control token followed by a placeholder indicating that one or more task tokens are to be predicted by the fine-tuned model. The fine-tuned model predicts one or more tasks, intents, or activities that the user is likely to perform, as described in further detail with respect to FIG. 12.

As shown in FIG. 9C, the server computing device 106 constructs the partial multimodal input sequence 910 using available user context data and ongoing interaction data associated with the current user session. The partial multimodal input sequence 910 may include user profile tokens, tokens representing one or more prior completed web sessions, call interaction data from prior call interactions, and tokens representing a partial current web session that remains ongoing. Unlike the sequences shown in FIGS. 9A and 9B, which are constructed from complete historical interaction data, the partial multimodal input sequence 910 in FIG. 9C reflects an incomplete current session—the [WEB_SESSION_STOP] token is absent from the current session because the session has not yet concluded. The partial multimodal input sequence 910 is provided to the fine-tuned model as input 912 to generate one or more predicted task tokens, as described with respect to FIG. 12.

In some embodiments, the model input 904, 908, or 912 may include all available data types for a user. In other embodiments, the model input 904, 908, or 912 may include only a subset of available data types. For example, the model input 904, 908, or 912 may include profile data and web session data without call interaction data, or may include profile data, call interaction data, and mobile activity data without a second web session. Missing or unavailable modalities may be omitted or represented using a null token, mask token, or other absence indicator. In some embodiments, the partial multimodal input sequence 910 used during inference (FIG. 9C) may include available modalities and omit unavailable modalities. Unavailable modalities may be represented using a null token, mask token, or other absence indicator, as described herein.

By generating unified customer interaction sequences as shown in FIGS. 9A, 9B, and 9C, the server computing device 106 may allow a single model to process heterogeneous customer interaction data in a common sequential format. This enables the model to learn relationships between different channels and modalities, such as relationships between profile attributes and webpage activity, between webpage activity and call interactions, or between call interactions and later digital navigation behavior.

### Pretraining of Foundation Model

As discussed above with respect to FIG. 9A, customer interaction data from different channels and modalities may be encoded into a unified customer interaction sequence for use during offline pretraining. FIG. 10 is a flow diagram illustrating an example process 1000 for pretraining a foundation model using historical customer interaction data, according to some embodiments. The process 1000 of FIG. 10 may be performed, for example, by the server computing device 106, the data retrieval module 106a, the task prediction module 106b, or a combination thereof.

At step 1002, historical interaction data is retrieved. The historical interaction data may include data associated with a plurality of users and may include, for example, historical page session data, historical clickstream data, historical call interaction data, call summary data, conversation log data, mobile activity data, chatbot interaction data, advisor interaction data, branch service data, task completion data, user profile data, or combinations thereof. In some embodiments, the historical interaction data may be retrieved from one or more databases or data sources associated with the system 100, including the page sessions database 120, user attributes database 130, user tasks database 140, or one or more additional customer interaction data sources. In some embodiments, the historical interaction data may include domain-specific natural language corpora. For example, the domain-specific natural language corpora may include frequently asked question pairs, virtual assistant question-answer pairs, service knowledge articles, product information articles, educational articles, call transcripts, call summaries, or other text data associated with tasks that users may perform.

In some embodiments, the historical interaction data may include multiple types of training samples having different channel and modality combinations. For example, a first set of training samples may include web session data including page name text, page tokens, and graph embeddings. A second set of training samples may include web session data paired with call interaction data occurring within a predetermined temporal window, such as within thirty minutes before or after a web session. A third set of training samples may include web session data paired with one or more task completion markers. A fourth set of training samples may include call transcripts, call summaries, chatbot question-answer pairs, domain-specific articles, service notes, or other natural language data. Training the foundation model using different combinations of modalities may improve robustness when one or more modalities are unavailable during inference.

At step 1004, multimodal event records are generated from the historical interaction data. As described above with respect to FIG. 8, each multimodal event record may represent a customer interaction enriched with contextual information. For example, a multimodal event record may include an event identifier, timestamp, content information, graph location information, session context information, channel information, or combinations thereof. In some embodiments, a page visit, mobile application interaction, call center interaction, chatbot interaction, advisor interaction, branch service interaction, or task completion event may each be represented as a corresponding multimodal event record.

At step 1006, the multimodal event records are arranged according to a time sequence to generate historical customer interaction sequences. For example, the system may arrange a sequence of webpage visits, a subsequent call interaction, and a later web session according to timestamps associated with the respective interactions. In some embodiments, the historical customer interaction sequences may represent customer journeys across multiple channels. In other embodiments, the historical customer interaction sequences may represent one or more sessions, portions of sessions, or time windows associated with a user.

At step 1008, the historical customer interaction sequences are encoded using control tokens and data tokens. Control tokens may identify a type of data, a channel, or a boundary within the sequence. For example, control tokens may include a user profile token, web session initiation token, web session stop token, call initiation token, call stop token, next task token, mobile session token, chatbot-session token, or other channel-specific or modality-specific token. Data tokens may include profile tokens, page tokens, task tokens, natural language tokens, call summary tokens, conversation tokens, mobile screen tokens, or other tokens representing customer interaction data.

At step 1010, the encoded historical customer interaction sequences are provided to a foundation model architecture. The foundation model architecture may include, for example, a transformer model, decoder-only transformer model, masked self-attention model, language model, large language model, generative artificial intelligence model, or other sequence model. In some embodiments, the foundation model architecture may be trained from scratch. In other embodiments, the foundation model architecture may be initialized from a pretrained model and further trained using the encoded historical customer interaction sequences.

At step 1012, the foundation model is trained using a causal language modeling objective. The foundation model may be trained to predict a next token, next event, next webpage, next interaction, next call-related token, next task token, or next portion of a customer interaction sequence based on preceding portions of the sequence. In this manner, the foundation model may learn temporal, contextual, and cross-channel relationships among different types of customer interactions, including relationships between webpage activity, call interactions, profile attributes, completed tasks, and subsequent user behavior.

At step 1014, model parameters, token embeddings, event embeddings, or other learned weights are updated based on the training. The system may update embeddings associated with webpage tokens, control tokens, task tokens, channel tokens, content features, graph location features, session context features, or other event dimensions. In some embodiments, updating the model parameters enables the foundation model to learn a representation of customer behavior across channels and modalities.

At step 1016, a pretrained foundation model artifact is generated and stored in a machine learning store, such as the machine learning store 110. The pretrained foundation model artifact may include learned model parameters, token embeddings, event embeddings, projection layer weights, attention weights, or other learned information. In some embodiments, the pretrained foundation model artifact may be used as an initial model for subsequent fine-tuning to predict one or more user tasks, intents, or activities. In some embodiments, the pretrained foundation model artifact may be periodically retrained or updated using additional historical customer interaction data.

Although FIG. 10 illustrates the steps in a particular order, it should be appreciated that one or more steps may be performed in a different order, omitted, repeated, or performed in parallel without departing from the scope of the disclosure. For example, generating multimodal event records and encoding historical customer interaction sequences may be performed as part of a common preprocessing operation.

### Fine-tuning Foundation Model for Task Prediction

The above-described foundation model may be pretrained using historical customer interaction sequences so that the model learns temporal, contextual, and cross-channel relationships among different types of customer interactions. FIG. 11 is a flow diagram illustrating an example process 1100 for fine-tuning the pretrained foundation model for task prediction, according to some embodiments. The process 1100 of FIG. 11 may be performed, for example, by the server computing device 106, the task prediction module 106b, or a combination thereof.

At step 1102, a pretrained foundation model artifact is retrieved. The pretrained foundation model artifact may be generated using the pretraining process described above with respect to FIG. 10. In some embodiments, the pretrained foundation model artifact may be retrieved from the machine learning store 110. The pretrained foundation model artifact may include learned model parameters, token embeddings, event embeddings, projection layer weights, attention weights, or other learned information generated during pretraining.

At step 1104, fine-tuning data is retrieved. The fine-tuning data may include data associated with one or more users and one or more completed tasks. For example, the fine-tuning data may include user profile data, demographic data, account data, transaction-related data, page session data, historical clickstream data, call interaction data, call summary data, conversation log data, mobile activity data, chatbot interaction data, advisor interaction data, branch service data, completed task data, or combinations thereof. In some embodiments, the completed task data may include completed task identifiers corresponding to tasks completed through one or more channels.

At step 1106, task prediction training sequences are generated. The task prediction training sequences may include one or more portions of customer interaction data and one or more completed task identifiers. For example, a task prediction training sequence may include profile tokens, webpage tokens, call summary text, task tokens, and control tokens. In some embodiments, the task prediction training sequence may include a next-task control token followed by one or more task tokens corresponding to a completed task or future task. In some embodiments, the completed task identifiers may be encoded according to a channel-agnostic task taxonomy, such that tasks completed through different interaction channels may be represented using common task identifiers.

At step 1108, a partial interaction sequence is provided to the model. The partial interaction sequence may include a portion of a task prediction training sequence that precedes one or more completed task identifiers. For example, the partial interaction sequence may include profile tokens, a partial webpage sequence, call summary text, mobile activity tokens, advisor interaction tokens, branch service tokens, or combinations thereof. In some embodiments, the partial interaction sequence may exclude one or more events associated with initiating or completing the task to be predicted. In this manner, the model may be fine-tuned to predict a task before the user expressly initiates or completes the task.

At step 1110, the model predicts one or more task tokens based on the partial interaction sequence. The one or more predicted task tokens may correspond to one or more tasks, intents, or activities that a user is likely to perform. In some embodiments, the predicted task tokens may correspond to tasks likely to be completed in the same channel represented in the partial interaction sequence. In other embodiments, the predicted task tokens may correspond to tasks likely to be completed in a different channel. For example, based on a partial website session and prior call-summary data, the model may predict a call center task, mobile application task, advisor service task, branch service task, or website task.

At step 1112, the predicted task tokens are compared with completed task identifiers. The completed task identifiers may represent ground-truth task labels for the task prediction training sequences. In some embodiments, the comparison may be performed using a loss function, scoring function, ranking objective, cross-entropy loss, multi-label loss, sequence generation loss, or other training objective. In some embodiments, the comparison may account for multiple completed task identifiers when a user interaction sequence is associated with multiple tasks.

At step 1114, model parameters are updated for a task prediction objective. For example, the system may update model parameters, token embeddings, event embeddings, attention weights, projection layer weights, classifier head weights, output token weights, or other learned parameters based on the comparison performed at step 1112. In some embodiments, the task prediction objective may train the model to output one or more task tokens following a next-task control token. In some embodiments, the task-prediction objective may train the model to rank a plurality of task tokens according to likelihood.

At step 1118, a fine-tuned task prediction model artifact is generated and stored in the machine learning store 110. The fine-tuned task prediction model artifact may include learned parameters adapted for predicting one or more tasks, intents, or activities based on partial customer interaction sequences. In some embodiments, the fine-tuned task prediction model artifact may be used during inference to predict tasks during an ongoing customer interaction. In some embodiments, the fine-tuned task prediction model artifact may be periodically updated using additional fine-tuning data.

Although FIG. 11 illustrates the steps in a particular order, it should be appreciated that one or more steps may be performed in a different order, omitted, repeated, or performed in parallel without departing from the scope of the disclosure. For example, generating task-prediction training sequences and providing partial interaction sequences to the model may be performed as part of a common fine-tuning operation.

### Inference Using Fine-tuned Foundation Model

The foundation model may be fine-tuned to predict one or more task tokens based on partial customer interaction sequences. FIG. 12 is a flow diagram illustrating an example inference process 1200 for using the fine-tuned foundation model to predict tasks and generate recommended outputs during an ongoing user interaction, according to some embodiments. The process of FIG. 12 may be performed, for example, by the server computing device 106, the data retrieval module 106a, the task prediction module 106b, the webpage management module 106d, or a combination thereof.

At step 1202, a fine-tuned foundation model artifact is retrieved. The fine-tuned foundation model artifact may correspond to the fine-tuned task prediction model artifact generated and stored according to the process 1100 described with respect to FIG. 11. In some embodiments, the fine-tuned foundation model artifact may be retrieved from the machine learning store 110. The fine-tuned foundation model artifact may include learned model parameters, token embeddings, event embeddings, projection-layer weights, attention weights, output token weights, or other learned information adapted for predicting one or more tasks, intents, or activities.

At step 1204, one or more ongoing user interactions are monitored. The ongoing user interactions may include interactions occurring through one or more channels, such as a website, mobile application, chatbot interface, virtual-assistant interface, call center channel, advisor channel, branch service channel, or other digital or communication channel. For example, the system may monitor webpages accessed by the user during a current web session, mobile screens accessed by the user during a mobile session, messages provided through a chatbot interface, or other interaction events associated with the user.

At step 1206, available user context data is retrieved. The available user context data may include user profile data, demographic data, account data, asset data, transaction-related data, prior page session data, prior call summary data, conversation log data, mobile activity data, completed task data, or other contextual data associated with the user. In some embodiments, the available user context data may be retrieved from the page sessions database 120, user attributes database 130, user tasks database 140, or one or more additional customer interaction data sources. In some embodiments, unavailable modalities may be omitted from the input or represented using a null token, mask token, absence indicator, or other token indicating that a modality is unavailable.

At step 1208, a partial multimodal input sequence is generated. The partial multimodal input sequence may include interaction data associated with the ongoing user interactions and one or more portions of the available user context data. For example, the partial multimodal input sequence may include a user profile control token followed by one or more user profile tokens, a web session initiation token followed by one or more webpage tokens associated with a current web session, call summary text from a prior call interaction, mobile activity tokens, conversation tokens, advisor interaction tokens, branch service tokens, or combinations thereof. In some embodiments, the partial multimodal input sequence may include a next-task control token indicating a position at which the model is to predict one or more task tokens.

At step 1210, the partial multimodal input sequence is provided to the fine-tuned model. The fine-tuned model may be a language model, large language model, transformer model, decoder-only transformer model, foundation model, generative artificial intelligence model, or other sequence model. In some embodiments, the partial multimodal input sequence may be provided to the model during an active user session and before the user completes a task. In some embodiments, the partial multimodal input sequence may exclude one or more events associated with initiating or completing the task that is later predicted by the model.

At step 1212, one or more predicted task tokens are determined. The one or more predicted task tokens may correspond to tasks, intents, or activities that the user is likely to perform. In some embodiments, the predicted task tokens may be represented according to a channel-agnostic task taxonomy. The predicted task tokens may correspond to tasks likely to be performed in the same channel as the ongoing user interaction or in a different channel. For example, based on an ongoing website session and available user context data, the model may predict that the user is likely to perform a call center task, mobile application task, advisor service task, branch service task, or website task. In some embodiments, the one or more predicted task tokens may be ranked according to likelihood. In some embodiments, the fine-tuned model may output a sequence of task tokens, a ranked list of task tokens, confidence scores, probability scores, embeddings, logits, natural language intent descriptions, or combinations thereof. In some embodiments, the task prediction module 106b may convert the output of the fine-tuned model into one or more predicted task identifiers according to the channel-agnostic task taxonomy.

At step 1214, the predicted task tokens are mapped to one or more recommended outputs. For example, a predicted task token may be mapped to recommended webpage content, a mobile application prompt, a chatbot prompt, a virtual assistant starter question, a service routing action, an advisor service recommendation, a branch service recommendation, a workflow shortcut, a product recommendation, or a next-best-action output. In some embodiments, the mapping may be performed by accessing a mapping table, recommendation engine, rules engine, task-to-content mapping, task-to-service mapping, or machine learning model.

At step 1218, one or more recommended outputs are generated or displayed. In some embodiments, the recommended outputs may include analytics outputs that are stored, transmitted, or used by another system without immediate display to the user. The recommended outputs may be displayed to the user through a website, mobile application, chatbot interface, virtual assistant interface, or other user interface. In some embodiments, the recommended outputs may be displayed to an employee, representative, advisor, or branch associate through an internal interface. In some embodiments, generating or displaying the recommended outputs may include modifying a webpage, re-ranking existing content, displaying a widget, generating a recommended question, routing the user to a service queue, presenting a workflow shortcut, or generating a next-best-action recommendation.

Although FIG. 12 illustrates the steps in a particular order, it should be appreciated that one or more steps may be performed in a different order, omitted, repeated, or performed in parallel without departing from the scope of the disclosure. For example, monitoring ongoing user interactions and retrieving available user context data may be performed continuously or periodically during a user session. In some embodiments, the process 1200 may be repeated as additional interaction events are received, such that predicted task tokens and recommended outputs are updated during the ongoing user interaction.

### Example Use Cases

In one example use case, the system may generate starter questions for a virtual assistant or chatbot welcome experience. For example, the system may process a user's recent web session, profile data, and prior interaction history to predict a top-N set of tasks. The virtual assistant may then display starter questions corresponding to the predicted tasks.

In another example use case, the system may support guided services for branch appointments. For example, the system may process recent click history, prior call summaries, profile attributes, transaction data, or other available modalities to predict one or more transactions or service tasks that the user is likely to perform during a branch interaction. The predicted tasks may be displayed to a branch associate or used to prepare a guided service workflow.

In another example use case, the system may perform anticipatory service routing. For example, if the system predicts that a user is likely to perform a call center task based on a current website session, the system may route the user to an appropriate service queue, generate a relevant chatbot prompt, or provide a recommended self-service workflow.

In another example use case, the system may perform digital friction analysis. For example, the system may identify sequences of interactions that frequently precede a call center interaction, abandonment event, repeated page visit, or failed task completion event. The system may generate a friction score, identify a webpage or workflow associated with the friction score, or recommend a user interface modification to reduce friction.

In another example use case, the system may perform customer segmentation. For example, embeddings generated from customer interaction sequences may be clustered or otherwise analyzed to identify groups of users having similar task intent patterns, channel preferences, service needs, or product interests.

In another example use case, the system may perform purchase funnel or task funnel analysis. For example, the system may identify events, pages, calls, or messages that frequently occur before or after completion of a target task, and may use such information to recommend content, modify a user interface, or route a user to a service channel.

### Terminology

The term “model,” as used in the present disclosure, can include computer-based models of any type and of any level of complexity, such as any type of sequential, functional, generative, predictive, discriminative, or concurrent model. Models can further include various types of computational models, such as, for example, artificial neural networks (“NNs”), machine learning (“ML”) models, artificial intelligence (“AI”) models, generative AI models, language models, large language models (“LLMs”), transformer models, decoder-only transformer models, encoder-decoder models, foundation models, multimodal models, graph-based models, embedding models, tabular-data encoders, and/or the like. In some embodiments, a model may receive one or more multimodal event records, customer interaction sequences, embeddings, tokens, text inputs, structured-data inputs, or combinations thereof, and may generate one or more predicted task tokens, task identifiers, intent identifiers, embeddings, rankings, scores, natural-language outputs, recommended outputs, or combinations thereof.

A “language model,” as used in the present disclosure, refers to any algorithm, rule, model, and/or other programmatic instructions configured to process, generate, score, or predict sequences of tokens. In some embodiments, the tokens may correspond to words, subwords, characters, webpage identifiers, page codes, task identifiers, control tokens, profile tokens, channel tokens, multimodal event records, or other discrete symbols. A language model may, given a starting sequence of one or more tokens, predict a next token or a probability distribution over possible next tokens. A language model may calculate probabilities of token sequences based on patterns learned during training. A language model may include n-gram models, statistical models, exponential models, positional models, neural network models, transformer models, and/or other sequence models.

A “large language model” or “LLM,” as used in the present disclosure, refers to a language model having a relatively large number of learned parameters, trained using a relatively large training corpus, or configured to perform one or more language-processing, sequence-processing, prediction, ranking, or generation tasks. An LLM may comprise an NN trained using supervised learning, unsupervised learning, self-supervised learning, reinforcement learning, instruction tuning, fine-tuning, continual pretraining, or combinations thereof. An LLM may be configured as a text-only model, multimodal model, question-answering model, conversational model, decoder-only transformer model, encoder-decoder model, or other sequence model.

A “foundation model,” as used in the present disclosure, refers to a model trained or pretrained on a broad corpus of training data and adaptable to one or more downstream tasks. In some embodiments, the foundation model may be pretrained using historical customer interaction sequences and fine-tuned to predict one or more tasks, intents, or activities. In some embodiments, a foundation model may comprise a language model, large language model, transformer model, decoder-only transformer model, multimodal model, generative AI model, or other sequence model.

A “multimodal model,” as used in the present disclosure, refers to a model configured to process input data from multiple modalities or data types. The modalities may include, for example, webpage identifiers, page-content information, website-graph information, timestamps, session-context data, call-summary text, conversation text, mobile-activity data, user-profile attributes, transaction data, task-completion data, images, audio, video, metadata, or combinations thereof. A multimodal model may process such inputs directly, or may process embeddings, tokens, or other representations generated from such inputs.

“Parameter-efficient fine-tuning,” as used in the present disclosure, refers to adapting a model to a downstream task by updating less than all parameters of the model or by adding one or more trainable components to the model. Parameter-efficient fine-tuning may include, for example, adapter tuning, prompt tuning, prefix tuning, low-rank adaptation, quantized low-rank adaptation, partial layer tuning, classifier head tuning, or combinations thereof. In some embodiments, parameter-efficient fine-tuning may be used to adapt a pretrained foundation model to predict task tokens from customer interaction sequences.

“Model distillation,” as used in the present disclosure, refers to training a first model to approximate, compress, reproduce, or otherwise learn from outputs, embeddings, rankings, probability distributions, or intermediate representations generated by a second model. In some embodiments, a larger foundation model may be used to train or generate labels for a smaller model that is deployed for lower-latency inference, edge inference, mobile inference, branch-service inference, or other resource-constrained environments.

“Model quantization,” as used in the present disclosure, refers to representing one or more model parameters, activations, embeddings, or other numerical values using reduced numerical precision. In some embodiments, quantization may be used to reduce memory usage, reduce compute requirements, improve inference latency, or enable deployment on resource-constrained hardware. Efficient inference techniques may also include batching, caching, pruning, speculative decoding, early exiting, routing to smaller models, or combinations thereof.

“Model observability,” “model evaluation,” or “monitoring,” as used in the present disclosure, refers to collecting, measuring, storing, or analyzing information associated with model inputs, outputs, intermediate representations, confidence scores, latency, drift, fairness, accuracy, task-completion outcomes, user interactions, or recommended outputs. In some embodiments, monitoring may be used to detect data drift, model drift, performance degradation, unsafe outputs, low-confidence predictions, or changes in task distributions. “Guardrail,” as used in the present disclosure, refers to a rule, model, policy, validation process, filter, constraint, approval workflow, or other control applied to model inputs, model outputs, recommended outputs, tool calls, or user-interface modifications. In some embodiments, a guardrail may prevent display of a recommended output, require human approval, restrict a service routing action, filter sensitive data, redact personal information, enforce privacy requirements, or validate that a predicted task token corresponds to an allowed task taxonomy.

“Tool calling” or “function calling,” as used in the present disclosure, refers to a process by which a model, model-serving system, or orchestration system identifies and invokes one or more external tools, functions, APIs, services, databases, workflows, or computing modules. For example, a model may invoke a retrieval function, task-taxonomy lookup function, recommendation function, service routing function, user profile retrieval function, page content retrieval function, graph feature retrieval function, or workflow execution function. In some embodiments, a tool call may be generated as structured output by the model and executed by a server computing device, orchestration module, or other system component.

An “agentic workflow” or “model orchestration workflow,” as used in the present disclosure, refers to a workflow in which one or more models, tools, rules engines, retrieval systems, or software modules are coordinated to perform a task. In some embodiments, an agentic workflow may include generating a model input sequence, retrieving user-context data, invoking a task-taxonomy service, scoring predicted task tokens, validating a predicted output, generating a recommended output, invoking a service-routing workflow, or updating a user interface. An agentic workflow may be deterministic, partially autonomous, fully automated, human-supervised, or human-in-the-loop.

A “structured output,” as used in the present disclosure, refers to model output that conforms to a predefined schema, format, grammar, data structure, or set of fields. For example, a structured output may include one or more task identifiers, task tokens, confidence scores, channel identifiers, recommended content identifiers, routing instructions, explanation fields, or next-best-action identifiers. In some embodiments, a structured output may be represented as JSON, XML, protocol-buffer data, database records, key-value pairs, or another machine-readable format.

Retrieval-augmented generation (“RAG”), as used in the present disclosure, refers to a technique in which a model generates, scores, ranks, or otherwise produces output based at least in part on information retrieved from one or more external data sources. The external data sources may include databases, knowledge bases, vector databases, document repositories, customer interaction records, page-content repositories, task-taxonomy databases, call-summary databases, conversation-log databases, or other sources. In some embodiments, retrieved information may be inserted into a prompt, encoded into a model input sequence, used to generate embeddings, used to rank candidate task tokens, or used to generate recommended outputs.

A “vector database,” “vector store,” or “embedding store,” as used in the present disclosure, refers to a data storage system configured to store, index, retrieve, or search vector representations of data. The vector representations may include page embeddings, event embeddings, content embeddings, graph embeddings, profile embeddings, task embeddings, conversation embeddings, or other numerical representations. In some embodiments, a vector database may retrieve one or more records based on similarity search, nearest-neighbor search, approximate nearest-neighbor search, hybrid keyword-and-vector search, filtering, re-ranking, or combinations thereof.

A “multimodal event record,” as used in the present disclosure, refers to a data record representing a customer interaction enriched with contextual information. A multimodal event record may correspond to, for example, a webpage visit, mobile application interaction, call-center interaction, chatbot interaction, virtual-assistant interaction, advisor interaction, branch-service interaction, task-completion event, or other digital or communication-channel interaction. In some embodiments, a multimodal event record may include an event identifier, timestamp, channel identifier, content information, graph-location information, session-context information, user-context information, task information, or combinations thereof.

A “customer interaction sequence,” as used in the present disclosure, refers to a sequence of customer interactions, multimodal event records, event embeddings, tokens, or other representations associated with a user session, customer journey, time window, or other ordered interaction period. In some embodiments, a customer interaction sequence may include interactions from a single channel, such as a website channel. In other embodiments, a customer interaction sequence may include interactions from multiple channels, such as a website channel, mobile application channel, call-center channel, chatbot channel, advisor channel, branch service channel, or combinations thereof.

An “event embedding,” as used in the present disclosure, refers to a vector or other numerical representation of a multimodal event record. In some embodiments, an event embedding may be generated based on an event identifier, timestamp, channel identifier, content information, graph location information, session context information, user-profile information, or combinations thereof. In some embodiments, modality-specific embeddings may be projected into a common embedding space and combined using weighted pooling, attention-based pooling, concatenation followed by projection, summation, averaging, or another embedding-combination operation.

A “control token,” as used in the present disclosure, refers to a token that identifies a type, boundary, channel, or function within a sequence. Examples of control tokens include, without limitation, a user profile token, web session initiation token, web session stop token, call initiation token, call stop token, mobile session token, chatbot session token, and next-task token. A “data token,” as used in the present disclosure, refers to a token representing underlying data, such as a page token, profile token, task token, channel token, natural language token, mobile-screen token, or other token.

A “task token” or “task identifier,” as used in the present disclosure, refers to a token or identifier representing a task, intent, activity, or service outcome associated with a user. In some embodiments, task tokens or task identifiers may be defined according to a channel-agnostic task taxonomy. A “channel-agnostic task taxonomy” refers to a task taxonomy in which tasks completed through different interaction channels may be mapped to common task identifiers when the tasks correspond to the same or similar user intent, activity, or service outcome.

A “recommended output,” as used in the present disclosure, refers to an output generated based on one or more predicted tasks, intents, or activities. A recommended output may include, for example, recommended webpage content, a mobile application prompt, a chatbot prompt, a virtual assistant starter question, a product recommendation, a service routing action, an advisor service recommendation, a branch service recommendation, a workflow shortcut, a next-best-action output, an analytics output, or a user interface modification.

While certain aspects and implementations are discussed herein with reference to use of a language model, LLM, foundation model, transformer model, multimodal model, or AI model, those aspects and implementations may be performed by any other language model, LLM, AI model, generative AI model, generative model, ML model, NN, multimodal model, statistical model, rules-based model, graph-based model, embedding model, or other algorithmic process. Similarly, while certain aspects and implementations are discussed herein with reference to use of an ML model, those aspects and implementations may be performed by any other AI model, generative AI model, generative model, NN, multimodal model, or other algorithmic process.

In various implementations, the LLMs and/or other models, including ML models, of the present disclosure may be locally hosted, cloud managed, accessed via one or more application programming interfaces (“APIs”), deployed in an on-premises computing environment, deployed in a hybrid computing environment, or any combination of the foregoing. Additionally, in various implementations, the LLMs and/or other models, including ML models, of the present disclosure may be implemented in or by electronic hardware, such as application-specific processors, application-specific integrated circuits (“ASICs”), programmable processors, field programmable gate arrays (“FPGAs”), graphics processing units (“GPUs”), tensor processing units (“TPUs”), neural processing units (“NPUs”), application-specific circuitry, and/or the like.

Data that may be queried, processed, generated, stored, encoded, embedded, or otherwise used by the systems and methods of the present disclosure may include any type of electronic data, such as text, files, documents, manuals, emails, images, audio, video, databases, metadata, positional data, geospatial data, sensor data, webpages, mobile application data, clickstream data, call transcripts, call summaries, chatbot conversations, advisor notes, branch-service notes, page content data, website graph data, task completion data, user profile data, transaction data, time-series data, and/or any combination of the foregoing. In various implementations, such data may comprise model inputs, model outputs, model training data, modeled data, recommended outputs, and/or the like.

Examples of models, language models, foundation models, and/or LLMs that may be used in various implementations of the present disclosure include, for example, encoder-only transformer models, decoder-only transformer models, encoder-decoder transformer models, bidirectional transformer models, GPT-family models, BERT-family models, LLaMA-family models, mixture-of-experts models, multimodal foundation models, retrieval-augmented models, domain-specific language models, small language models, distilled language models, graph neural networks, tabular-data models, embedding models, ranking models, and other transformer-based or non-transformer-based models. Any reference to a specific model architecture or model family is illustrative and non-limiting.

The above-described techniques can be implemented using computer hardware, firmware, software, specialized circuitry, cloud-based computing resources, edge-computing resources, or combinations thereof. In some embodiments, the techniques may be implemented as one or more computer program products tangibly embodied in one or more non-transitory computer-readable storage media for execution by, or to control the operation of, one or more data processing apparatuses, including one or more processors, computers, servers, virtual machines, containers, serverless computing functions, model-serving systems, inference servers, training servers, or distributed computing systems.

A computer program can be written in any suitable programming language or machine-executable format, including source code, compiled code, interpreted code, bytecode, script code, containerized code, machine code, model-execution instructions, orchestration instructions, or combinations thereof. The computer program can be deployed as a stand-alone program, application, service, microservice, module, library, subroutine, function, container, workflow, pipeline, or other executable unit suitable for use in a computing environment. The computer program can be deployed to execute on one computing device, on multiple computing devices at one site, on multiple computing devices distributed across multiple sites, in a public cloud, private cloud, hybrid cloud, edge computing environment, on-premises environment, or combinations thereof.

Method steps can be performed by one or more processors executing computer-executable instructions to perform functions described herein by operating on input data, generating output data, invoking one or more models, retrieving data from one or more data stores, generating embeddings, updating model parameters, performing inference, generating recommended outputs, or combinations thereof. Method steps can also be performed by, and apparatuses can be implemented as, special-purpose logic circuitry, such as application-specific integrated circuits (“ASICs”), field-programmable gate arrays (“FPGAs”), system-on-chip devices (“SoCs”), programmable logic devices, graphics processing units (“GPUs”), tensor processing units (“TPUs”), neural processing units (“NPUs”), digital signal processors (“DSPs”), application-specific instruction-set processors (“ASIPs”), or combinations thereof.

Processors suitable for executing the techniques described herein may include general-purpose processors, central processing units (“CPUs”), GPUs, TPUs, NPUs, AI accelerators, inference accelerators, training accelerators, microcontrollers, digital signal processors, special-purpose processors, or combinations thereof. Generally, a processor receives instructions and data from one or more memory devices, such as random-access memory, read-only memory, cache memory, high-bandwidth memory, persistent memory, flash memory, storage-class memory, or combinations thereof. A computing system may also include or be operatively coupled to one or more storage systems, including local storage, network-attached storage, object storage, distributed storage, database storage, vector storage, embedding storage, or other storage resources.

Computer-readable storage media suitable for embodying computer program instructions and data include volatile and non-volatile memory and storage media, including semiconductor memory devices, solid-state drives, flash memory devices, magnetic storage devices, optical storage devices, persistent memory devices, network-accessible storage systems, cloud storage systems, object stores, database systems, vector databases, embedding stores, and other tangible storage media. The term “computer-readable storage medium” does not encompass a transitory propagating signal.

To provide interaction with a user, the above-described techniques can be implemented on or through one or more user interfaces. The user interfaces may be presented using a display device, touchscreen, mobile device display, wearable-device display, vehicle display, kiosk display, augmented-reality display, virtual-reality display, mixed-reality display, projected display, or other output device. User input may be received using a keyboard, pointing device, mouse, trackpad, touchscreen, microphone, camera, biometric sensor, motion sensor, gesture-recognition system, speech-recognition system, haptic interface, stylus, controller, or other input device. Feedback may include visual feedback, auditory feedback, tactile feedback, haptic feedback, natural-language feedback, graphical feedback, or combinations thereof.

The above-described techniques can be implemented in a distributed computing system that includes one or more back-end components, middleware components, front-end components, model-serving components, orchestration components, data-processing components, or combinations thereof. A back-end component may include a data server, application server, model server, inference server, training server, feature store, embedding store, vector database, workflow engine, recommendation engine, task-taxonomy service, or database server. A front-end component may include a web interface, mobile application interface, chatbot interface, virtual assistant interface, call center interface, advisor interface, branch service interface, administrative interface, dashboard, or other interface through which a user, representative, service associate, or system administrator may interact with an implementation.

Components of the computing system can be interconnected by one or more communication networks or other transmission media. The communication networks may include wired networks, wireless networks, cellular networks, local area networks, wide area networks, enterprise networks, cloud networks, virtual private networks, software-defined networks, content delivery networks, edge networks, private networks, public networks, or combinations thereof. In some embodiments, communication among components may occur using one or more network protocols or messaging mechanisms, including Internet Protocol (“IP”), Transmission Control Protocol (“TCP”), User Datagram Protocol (“UDP”), Hypertext Transfer Protocol (“HTTP”), secure Hypertext Transfer Protocol (“HTTPS”), WebSocket protocols, message queues, publish-subscribe messaging, remote procedure calls, streaming protocols, event buses, or application programming interfaces.

Devices of the computing system can include, for example, servers, desktop computers, laptop computers, tablets, smartphones, wearable devices, smart speakers, kiosks, point-of-service terminals, branch-service terminals, advisor workstations, call center workstations, mobile devices, edge devices, embedded devices, Internet-of-Things (“IoT”) devices, or other computing or communication devices. In some embodiments, a user may interact with the system through a browser, mobile application, chatbot, virtual assistant, voice interface, branch service interface, advisor interface, or other interface.

The above-described techniques can be implemented using supervised learning, unsupervised learning, semi-supervised learning, self-supervised learning, reinforcement learning, continual pretraining, fine-tuning, instruction tuning, prompt tuning, parameter-efficient fine-tuning, adapter tuning, embedding learning, metric learning, contrastive learning, causal language modeling, masked language modeling, sequence-to-sequence learning, multi-label classification, ranking, retrieval, generation, distillation, quantization-aware training, or combinations thereof. Self-supervised learning may include training a model to predict part of an input sequence from another part of the input sequence, such as predicting a next token, masked token, next event, next task token, or other withheld portion of a customer interaction sequence.

The terms “comprise,” “include,” and plural forms of each are open-ended and include the listed parts and can include additional parts that are not listed. The term “and/or” is open-ended and includes one or more of the listed parts and combinations of the listed parts. Unless otherwise indicated, ordinal terms such as “first,” “second,” and “third” are used for identification and do not require a particular order. Unless otherwise indicated, the terms “based on” and “based at least in part on” include direct and indirect reliance on one or more items. Unless otherwise indicated, references to “real time” include near-real-time, periodic, event-driven, streaming, batch, or micro-batch processing suitable for a corresponding implementation..

One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A computerized method for predicting tasks that a user performs across one or more interaction channels, the method comprising:
training a machine learning model, at a first stage, based on historical customer interaction data corresponding to each of one or more users who have previously interacted with a website or one or more additional interaction channels, wherein the historical customer interaction data includes one or more customer interaction sequences, each customer interaction sequence being a sequence of multimodal event records associated with a user session or user journey, wherein each multimodal event record corresponds to a customer interaction and includes an event identifier, a timestamp, a channel identifier, and one or more modality-specific features, and wherein, during the first stage, each multimodal event record in a customer interaction sequence is interpreted as a lexical token and the machine learning model is trained to generate an event embedding for each lexical token based upon model learning derived from past customer interaction sequences;
training the machine learning model, at a second stage, based on customer interaction data, user attribute data, and user task data, wherein the second stage comprises fine-tuning the machine learning model to predict a task associated with a training customer interaction sequence using only a partial sequence of multimodal event records from the training customer interaction sequence;
determining, by the machine learning model, during an ongoing user session and prior to completion of a task, one or more predicted tasks after a predetermined number of customer interactions have occurred in the ongoing user session, wherein the one or more predicted tasks are determined based on at least one of the predetermined number of customer interactions and the user attribute data; and
generating one or more recommended content items based on the one or more predicted tasks, wherein the one or more recommended content items are displayed to the user on a page or interface that is currently being accessed by the user and wherein the one or more recommended content items are generated independently of an explicit user approval to create a task record.

2. The method of claim 1, wherein interpreting each multimodal event record as a lexical token comprises mapping each multimodal event record to a discrete event identifier representing the corresponding customer interaction within the machine learning model.

3. The method of claim 2, wherein the discrete event identifier is derived from at least one of a URL, a canonicalized URL, a page hash, an internal page reference, a mobile screen identifier, a call event identifier, a channel identifier, or a task identifier.

4. The method of claim 1, wherein the user task data includes one or more tasks that have been previously completed by the user through at least one of the website or the one or more additional interaction channels, and wherein the one or more tasks are expressed according to a channel-agnostic task taxonomy.

5. The method of claim 4, wherein the one or more predicted tasks include a predicted task likely to be performed through an interaction channel different from an interaction channel of at least one customer interaction in the partial sequence of multimodal event records.

6. The method of claim 1, further comprising extracting, in real time, a plurality of customer interactions that have occurred within a predetermined time period during the ongoing user session.

7. The method of claim 6, further comprising determining one or more customer interactions of the plurality of customer interactions, the one or more customer interactions being a subset of the plurality of customer interactions, wherein the machine learning model determines at least one predicted task after an end of the predetermined time period, and wherein the at least one predicted task is determined by the machine learning model based on the one or more customer interactions.

8. The method of claim 1, wherein the partial sequence of multimodal event records excludes at least one multimodal event record associated with completion of the predicted task.

9. The method of claim 8, wherein the predicted task is determined prior to user interaction with a webpage, mobile screen, call interaction, chatbot interaction, advisor interaction, branch service interaction, or other interaction point that initiates execution of the predicted task.

10. The method of claim 1, wherein the page or interface that is currently being accessed by the user includes a chatbot, wherein the chatbot includes an input section to receive queries from the user, an output section to display a response to the queries, and a recommended content section that includes the one or more recommended content items, and wherein the recommended content items in the recommended content section are each associated with a query that was generated or extracted based on a corresponding predicted task of the one or more predicted tasks.

11. A system for predicting tasks that a user performs across one or more interaction channels, the system comprising a computing device with a memory for storing computer-executable instructions and one or more processors that execute the computer-executable instructions to:
train a machine learning model, at a first stage, based on historical customer interaction data corresponding to each of one or more users who have previously interacted with a website or one or more additional interaction channels, wherein the historical customer interaction data includes one or more customer interaction sequences, each customer interaction sequence being a sequence of multimodal event records associated with a user session or user journey, wherein each multimodal event record corresponds to a customer interaction and includes an event identifier, a timestamp, a channel identifier, and one or more modality-specific features, and wherein, during the first stage, each multimodal event record in a customer interaction sequence is interpreted as a lexical token and the machine learning model is trained to generate an event embedding for each lexical token based upon model learning derived from past customer interaction sequences;
train the machine learning model, at a second stage, based on customer interaction data, user attribute data, and user task data, wherein the second stage comprises fine-tuning the machine learning model to predict a task associated with a training customer interaction sequence using only a partial sequence of multimodal event records from the training customer interaction sequence;
determine, by the machine learning model, during an ongoing user session and prior to completion of a task, one or more predicted tasks after a predetermined number of customer interactions have occurred in the ongoing user session, wherein the one or more predicted tasks are determined based on at least one of the predetermined number of customer interactions and the user attribute data; and
generate one or more recommended content items based on the one or more predicted tasks, wherein the one or more recommended content items are displayed to the user on a page or interface that is currently being accessed by the user and wherein the one or more recommended content items are generated independently of an explicit user approval to create a task record.

12. The system of claim 11, wherein interpreting each multimodal event record as a lexical token comprises mapping each multimodal event record to a discrete event identifier representing the corresponding customer interaction within the machine learning model.

13. The system of claim 12, wherein the discrete event identifier is derived from at least one of a URL, a canonicalized URL, a page hash, an internal page reference, a mobile screen identifier, a call event identifier, a channel identifier, or a task identifier.

14. The system of claim 11, wherein the user task data includes one or more tasks that have been previously completed by the user through at least one of the website or the one or more additional interaction channels, and wherein the one or more tasks are expressed according to a channel-agnostic task taxonomy.

15. The system of claim 14, wherein the one or more predicted tasks include a predicted task likely to be performed through an interaction channel different from an interaction channel of at least one customer interaction in the partial sequence of multimodal event records.

16. The system of claim 11, wherein the computing device extracts, in real time, a plurality of customer interactions that have occurred within a predetermined time period during the ongoing user session.

17. The method of claim 16, wherein the computing device determines one or more customer interactions of the plurality of customer interactions, the one or more customer interactions being a subset of the plurality of customer interactions, wherein the machine learning model determines at least one predicted task after an end of the predetermined time period, and wherein the at least one predicted task is determined by the machine learning model based on the one or more customer interactions.

18. The system of claim 11, wherein the partial sequence of multimodal event records excludes at least one multimodal event record associated with completion of the predicted task.

19. The system of claim 18, wherein the predicted task is determined prior to user interaction with a webpage, mobile screen, call interaction, chatbot interaction, advisor interaction, branch service interaction, or other interaction point that initiates execution of the predicted task.

20. The system of claim 11, wherein the page or interface that is currently being accessed by the user includes a chatbot, wherein the chatbot includes an input section to receive queries from the user, an output section to display a response to the queries, and a recommended content section that includes the one or more recommended content items, and wherein the recommended content items in the recommended content section are each associated with a query that was generated or extracted based on a corresponding predicted task of the one or more predicted tasks.
